(19) United States
(12) Patent Application Publication
(10) Pub. No.: US 2026/0252394 A1
(43) Pub. Date: Aug. 27, 2026

(54) REAL-TIME MODEL ADAPTATION BASED ON RESOURCE PROFILING FOR AI SYSTEMS AND APPLICATIONS

(71) Applicant: NVIDIA CORPORATION, Santa Clara, CA (US)

(72) Inventors: Barath Lakshmanan, Gilbert, AZ (US); Jason Lavar Clemons, Leander, TX (US); Iuri Frosio, Bergamo (IT); Maying Shen, Fremont, CA (US); Jose Manuel Alvarez Lopez, Mountain View, CA (US)

(21) Appl. No.: 19/203,453

(22) Filed: May 9, 2025

Related U.S. Application Data
(63) Continuation of application No. 19/203,443, filed on May 9, 2025.

(30) Foreign Application Priority Data
Feb. 26, 2025 (IT) 102025000003906

(51) Int. Cl. G06F 9/50

(52) U.S. Cl. CPC G06F 9/5027

(57) ABSTRACT

In various examples, a multi-configuration model may be dynamically scaled or optimized by modifying its structure or parameters during inference or runtime based on specified performance constraints (e.g., latency, accuracy, power or energy consumption) and a (e.g., current, predicted future) resource profile of the processor (e.g., a graphics processing unit (GPU), AI accelerator, etc.) executing the model. For example, resource profiling may be performed at one or more levels of monitoring and/or prediction to generate corresponding (e.g., current, near-term, long-term, external) resource profile(s) representing different points in time, and multiple levels of profiling may be combined to provide more accurate predictions. As such, a configuration selection model may be used to select the best configuration of a multi-configuration model based on one or more resource profiles, and the selected configuration may be activated to dynamically scale or optimize the model during inference or runtime in response to fluctuating resource availability.

### CROSS-REFERENCE TO RELATED APPLICATIONS

This application is a continuation of and claims priority to U.S. application Ser. No. 19/203,443, filed on May 9, 2025, which claims priority to Italian Application No. IT 102025000003906, filed on Feb. 26, 2025. The contents of each of the foregoing applications are hereby incorporated by reference in their entirety.

### BACKGROUND

Modern artificial intelligence (AI) systems, particularly those leveraging the intricate architectures of deep neural networks (DNNs), are frequently tasked with operating in real-time scenarios for applications such as those in autonomous vehicles, medical diagnostics, and edge computing, where instantaneous processing and decision-making are paramount. However, the ability of these systems to consistently meet real-time demands is often constrained by unpredictable fluctuations in available resources. Variations in memory, computational power, or energy supply—which are common in computing environments—can disrupt the functioning of these AI systems.

While significant strides have been made in model optimization, including techniques such as pruning (removing redundant parameters) and quantization (reducing precision of computations), these methods are typically employed in a static, offline context. The primary focus of these approaches is to compress the model size and improve efficiency before deployment. However, they are generally not designed to dynamically adapt to changing resource conditions during real-time operation. As a result, while these techniques can help reduce the overall computational footprint, they do not fully address the challenges posed by fluctuating runtime constraints.

Existing techniques for managing AI systems in dynamic environments have a variety of limitations. For example, static compression techniques like pruning and quantization may be used to provide one-time improvements to AI models by reducing their size and computational requirements. However, these techniques cannot adapt to varying runtime conditions. A statically compressed model may exceed desired performance requirements when a lower level of accuracy or speed would suffice, leading to unnecessary resource consumption. On the other hand, a simpler, pre-optimized model may fall short of delivering a desired level of performance when there are resources available to run a more complex configuration. While approaches like dynamic batching attempt to optimize hardware performance for batched tasks, they typically cannot adapt to varying performance requirements or fluctuating resource availability in real time. As a result, their limited scope often makes them unsuitable for real-time applications.

As such, there is a need for improved AI deployment techniques that balance performance, resource constraints, and task complexity in real time.

### SUMMARY

Embodiments of the present disclosure relate to real-time model adaptation for AI systems and applications. Systems and methods are disclosed that dynamically scale or optimize a multi-configuration model by modifying its structure or parameters during inference or runtime based on specified performance constraints (e.g., latency, accuracy, power or energy consumption) and a (e.g., current, predicted future) resource profile of the processor (e.g., a graphics processing unit (GPU), AI accelerator, etc.) executing the model.

In contrast to conventional systems, such as those described above, a supported configuration of a multi-configuration model may be selected based on a current and/or predicted future resource profile (representing one or more resource metrics that quantify or otherwise represent the occupancy, availability, performance potential, or actual output of one or more resources, such as compute resources, memory, memory bandwidth, power or energy, etc.) of the processor (e.g., a graphics processing unit (GPU), AI accelerator, etc.) that will run the model. For example, resource profiling may be performed at one or more levels of monitoring and/or prediction to generate corresponding (e.g., current, near-term, long-term, external) resource profile(s) representing different points in time, and multiple levels of profiling may be combined to provide more accurate predictions.

In some embodiments, a configuration selection model may be used to select the best configuration of a multi-configuration model based on one or more resource profiles (e.g., internal/external, current/near-term/long-term), user or application specified performance constraints (e.g., accuracy, latency, power/energy consumption), and/or a representation of the expected performance of one or more supported model configurations. The configuration selection model may be implemented using any suitable architecture (e.g., reinforcement learning, model predictive control, Bayesian optimization, etc.). As such, the configuration selection model may effectively monitor the hardware environment and specified performance constraints continuously, using a current resource profile to evaluate real-time hardware constraints, a predicted near-term resource profile to anticipate upcoming resource demands, and/or a predicted long-term resource profile to identify potential bottlenecks. Accordingly, the configuration selection model may dynamically select the most appropriate multi-configuration model configuration tailored to a specified target performance or performance constraint(s), striking an optimized balance between accuracy and efficiency.

Accordingly, the techniques described herein may be used to predict future hardware availability and/or perform model scaling or optimization on the fly based on available (e.g., current, predicted future) hardware resources.

### BRIEF DESCRIPTION OF THE DRAWINGS

The present systems and methods for real-time model adaptation for AI systems and applications are described in detail below with reference to the attached drawing figures, wherein:

FIG. 1 illustrates possible fluctuations in available system resources, in accordance with some embodiments of the present disclosure;

FIG. 2 illustrates an example data flow through an example model adaptation system, in accordance with some embodiments of the present disclosure;

FIG. 3 illustrates an example resource profiling system, in accordance with some embodiments of the present disclosure;

FIG. 4 depicts an example adaptive scaling system, in accordance with some embodiments of the present disclosure;

FIG. 5 is a flow diagram showing a method for generating an adapted or scaled configuration of a multi-configuration model selected using a configuration selection model, in accordance with some embodiments of the present disclosure;

FIG. 6 is a flow diagram showing a method for generating an adapted or scaled configuration of a multi-configuration model based at least on one or more resource profiles, in accordance with some embodiments of the present disclosure;

FIG. 7 is a block diagram of an example computing device suitable for use in implementing some embodiments of the present disclosure;

FIG. 8 illustrates a parallel processing unit, in accordance with some embodiments of the present disclosure;

FIG. 9A illustrates a general processing cluster within the parallel processing unit of FIG. 8, in accordance with some embodiments of the present disclosure;

FIG. 9B illustrates a memory partition unit of the parallel processing unit of FIG. 8, in accordance with some embodiments of the present disclosure;

FIG. 10A illustrates the streaming multi-processor of FIG. 9A, in accordance with some embodiments of the present disclosure;

FIG. 10B is a conceptual diagram of a processing system implemented using the PPU of FIG. 8, in accordance with some embodiments of the present disclosure;

FIG. 10C illustrates an example system in which the processing system of FIG. 10B may be implemented, in accordance with some embodiments of the present disclosure; and

FIG. 11 is a block diagram of an example data center suitable for use in implementing some embodiments of the present disclosure.

### DETAILED DESCRIPTION

Systems and methods are disclosed relating to real-time model adaptation for AI systems and applications. For example, a multi-configuration model may be dynamically scaled or optimized by modifying the structure or parameters of the model during inference or runtime based on specified performance constraints (e.g., latency, accuracy, power or energy consumption) and a (e.g., current, predicted future) resource profile of the processor (e.g., a graphics processing unit (GPU), AI accelerator, etc.) executing the model. The present techniques may be used to adapt the deployed configuration of models such as deep neural networks (DNN) in response to real-time resource occupancy or availability, optimizing for efficiency without sacrificing accuracy on simpler tasks, and maintaining suitable performance on more complex tasks when there is sufficient resource availability. The present techniques may be used to dynamically deploy and switch model configurations for applications in domains such as perception (e.g., in robotics, autonomous vehicles, etc.), medical diagnostics or imaging, edge computing, simulation applications, natural language processing, virtual reality (VR), augmented reality (AR), and/or other application types where a balance between model performance and computational efficiency may be desirable.

More specifically, a multi-configuration model (e.g., a neural network, random forest, image generation model, etc.) may be generated with multiple possible configurations or operational modes, which may be tailored to different resource profiles (e.g., resource availability, occupancy, etc.) and/or specified performance requirements (e.g., accuracy, latency, power/energy consumption). Taking a multi-configuration model such as a multi-configuration neural network as an example, each configuration may represent a unique combination of architectural settings, such as the network's depth (e.g., number of layers), width (e.g., number of neurons per layer), kernel size, and/or input resolution. For example, a shallow, narrow configuration may prioritize low latency and energy efficiency, whereas a deeper, wider configuration may maximize accuracy when resource availability is higher.

In some embodiments, each configuration may be represented or referenced in one or more data structures—such as a look-up table—and may be indexed based on some representation of the architecture or complexity of the model configuration (e.g., an index or ID, depth, width, kernel size, resolution, number of trained parameters, etc.) and/or expected performance (e.g., latency, accuracy, etc.). For example, the different model configurations may be indexed using a parameterized representation of architecture or complexity as keys paired or associated with an identification of the corresponding configuration (e.g., a model hash) as values. In some embodiments, the look-up table or other data structure(s) may associate each configuration (e.g., its model hash) with corresponding configuration data comprising a representation of the model architecture, a model prune mask (e.g., identifying block(s), layer(s), channel(s), neuron(s), and/or other features to be removed from the model architecture), precision flag(s) (e.g., specifying the numerical precision to be used in computations corresponding to components of the model such as blocks, layers, or channels), and/or other characteristics. As such, the model may be dynamically scaled or optimized on the fly by selecting one of the indexed configurations (as explained in more detail below), looking up a corresponding hash, and running the corresponding model configuration using the associated pruning mask and/or precision flags to optimize the model. For example, pruning may reduce overall complexity, and mixed precision computations may leverage hardware accelerators for speed and resource efficiency. This approach may be understood as a form of dynamic compression that balances efficiency and performance, adapting the model dynamically to meet deployment constraints such as available resources and specified performance requirements.

In some embodiments, a supported configuration of a multi-configuration model may be selected based on a current and/or predicted future resource profile (representing one or more resource metrics that quantify or otherwise represent the occupancy, availability, performance potential, or actual output of one or more resources, such as compute resources, memory, memory bandwidth, power or energy, etc.) of the processor (e.g., a graphics processing unit (GPU), AI accelerator, etc.) that will run the model. For example, resource profiling may be performed at one or more levels of monitoring and/or prediction to generate corresponding (e.g., current, near-term, long-term, external) resource profile(s) representing different points in time, and multiple levels of profiling may be combined to provide more accurate predictions. Generally, the complex architecture of AI accelerators (e.g., GPUs with multiple cores, shared memory, and various functional units) that speed up artificial intelligence (AI) and machine learning applications makes resource management challenging. Embodiments that perform multiple levels of resource profiling facilitate more effective control of model scaling, optimization, or compression while maintaining optimized performance in the presence of fluctuating resource constraints.

For example, in some embodiments, the processor may include profiling functionality that interfaces with the processor's compute engine to quantify or otherwise represent one or more aspects of a current (internal) resource profile comprising one or more resource metrics that represent the occupancy, availability, performance potential, or actual output of resources of the processor. For example, some GPUs provide mechanisms to estimate or measure the clock frequency of the GPU cores, the power or energy being consumed in real-time, how much memory is being used and how much is free, utilization rates, throughput, cache hits, Streaming Multiprocessor (SM) metrics (e.g., occupancy rate (e.g., the percentage of active threads relative to the total possible threads), warp execution efficiency (e.g., how effectively thread groups execute without divergence), register or shared memory usage per SM, etc.), and/or otherwise. Additionally or alternatively, the processor may include profiling functionality that interfaces with an external environment to quantify or otherwise represent one or more aspects of an external resource profile comprising one or more resource metrics that represent the occupancy, availability, performance potential, or actual output of resource(s) that exist outside the processor but may still influence its operation (e.g., the current load of a system that shares task execution responsibilities with the processor, an expected load pattern, a configuration or health status of a system the processor is part of such as the number of available GPUs or CPUs, etc.). As such, any number of resource metrics may be collected and encoded.

In some embodiments, the current internal resource profile, the external resource profile, and/or other information may be used to predict a future resource profile such as a near-term resource profile representing predicted near-term future resource conditions (e.g., one inference away in the future) and/or a long-term resource profile representing predicted long-term future resource conditions (e.g., some number of inferences away in the future).

In some embodiments, a near-term resource profile may additionally or alternatively be predicted based on pipeline activity data representing one or more aspects of the processor's fetch pipeline, such as detected types of instructions sent through the fetch pipeline (e.g., detected from prefetch mechanisms, instruction caches (L1 I-cache), main memory), the number of queued instructions, the size of data moving through the fetch pipeline (e.g., detected from data caches (e.g., L1 D-cache) or main memory), tracked performance indicators (e.g., missed fetches, stalls, latencies, throughput), and/or otherwise. As such, a resource prediction model (e.g., a neural network, a look-up table) may be used to map pipeline activity data, the current internal resource profile, and/or the external resource profile to a corresponding estimate of one or more resource metrics that represent the expected near-term occupancy, availability, performance potential, or actual output of one or more resources of the processor (e.g., compute occupancy or availability, memory occupancy or availability, memory bandwidth power or energy consumption, core frequency, throughput, etc.). Taking a simple example, certain types of instructions (e.g., memory fetches, tensor operations, activation functions, control flow instructions) and/or input data size may be predictive of one or more aspects of a near-term resource occupancy, so a look-up table may be used to map designated types of instructions and/or input data size to a corresponding estimated occupancy metric. In a more detailed example, any or all of the foregoing features may be encoded and applied to a neural network trained to predict one or more aspects of near-term resource occupancy. These are just a few examples, and variations are contemplated within the scope of the present disclosure.

Additionally or alternatively, a long-term resource profile may be predicted based on one or more categories of operations detected from a computational graph organizing the operations of a multi-configuration model for execution. Generally, certain types of operations may be predictive of one or more aspects of long-term resource occupancy. For example, transformer blocks typically rely on operations such as attention mechanisms and dense matrix multiplications, which may strain memory bandwidth and occupy substantial compute resources. By contrast, convolutional neural network (CNN) layers tend to reuse small patches of input data, which may reduce memory bandwidth demands relative to compute. As such, a computational graph compiled for a particular configuration of a multi-configuration model may be parsed to identify whether designated categories of operations are present (e.g., matrix multiplications, convolutions, activations, data movement, operations corresponding to a type of neural network layer, etc.). Accordingly, a resource prediction model (e.g., a neural network, a look-up table, a transformer) may be used to map detected categories of computational graph operations, the current internal resource profile, and/or the external resource profile to a corresponding estimate of one or more resource metrics that represent an expected long-term occupancy, availability, performance potential, or actual output of one or more resources of the processor (e.g., compute occupancy or availability, memory occupancy or availability, memory bandwidth power or energy consumption, core frequency, throughput, etc.). Taking a resource prediction model implemented using a transformer neural network as an example, a transformer may be used to encode the computation graph into a sequence of tokens, which may be applied to a neural network trained to predict one or more aspects of a long-term resource profile. These are just a few examples, and variations are contemplated within the scope of the present disclosure.

As such, a current internal resource profile, a predicted near-term internal resource profile, a predicted long-term internal resource profile, and/or an external resource profile may be used to select the best configuration of a multi-configuration model. Embodiments that combine or consider multiple profiling levels (e.g., current, near-term, and long-term resource profiles) facilitate a more comprehensive and dynamic resource management strategy than prior techniques. Real-time monitoring provides substantially immediate feedback, near-term prediction enables proactive allocation, and long-term prediction facilitates intelligent task scheduling and optimization.

More specifically, in some embodiments, a configuration selection model may be used to select the best configuration of a multi-configuration model based on one or more resource profiles (e.g., internal/external, current/near-term/long-term), user or application specified performance constraints (e.g., accuracy, latency, power/energy consumption), and/or a representation of the expected performance of one or more supported model configurations. In some embodiments, a multi-configuration model may include or be associated with a performance estimation model (e.g., a neural network, a look up table, etc.) that may be used to estimate the performance of a given model configuration (e.g., latency, energy, power, etc.) based on model configuration or complexity (e.g., depth, width, kernel size, resolution, number of trained parameters, etc.) and/or based on a specified (e.g., current, future) resource profile. As such, the estimated performance of a model configuration may additionally or alternatively be used by the configuration selection model to select a configuration. In some embodiments, the performance estimation model may be part of the configuration selection model such that the configuration selection model implicitly estimates the performance of one or more model configurations.

The configuration selection model may be implemented using any suitable architecture (e.g., reinforcement learning, model predictive control, Bayesian optimization, etc.). In some embodiments, the configuration selection model implements a multi-class classifier (e.g., a classifier that uses classes corresponding to parameters to index the different configurations of the multi-configuration model, with a number of classes that correspond to a number of indexed configurations of the multi-configuration model, etc.), and the performance estimation model and/or configuration selection model may periodically evaluate corresponding inputs, predict the best model configuration, and apply a designated prediction threshold to determine whether or not to switch to a predicted configuration. In some embodiments, the performance estimation model and/or configuration selection model may be used to predict the performance of a currently active model configuration and compare the predicted performance to user or application specified performance constraints to determine whether the currently active model configuration is predicted to comply. If so, the configuration selection model may determine to continue using the current configuration. Otherwise, it may test one or more alternate configurations and select one that satisfies the user or application specified performance (e.g., the first identified configuration predicted to satisfy the specified performance constraints, testing all supported configurations and selecting the one with the best predicted performance, etc.). In some embodiments, there may be multiple supported configuration selection models (e.g., one that focuses on optimizing latency, one that focuses on optimizing memory, etc.), and one may be selected and used based on the user or application specified performance constraints.

As such, the configuration selection model may effectively monitor the hardware environment and specified performance constraints continuously, using a current resource profile to evaluate real-time hardware constraints, a predicted near-term resource profile to anticipate upcoming resource demands, and/or a predicted long-term resource profile to identify potential bottlenecks. Accordingly, the configuration selection model may dynamically select the most appropriate multi-configuration model configuration, striking an optimized balance between accuracy and efficiency. For example, if the hardware (e.g., AI accelerator) is resource-constrained or the workload is computationally intensive, the configuration selection model may choose a smaller, less complex model configuration to adapt to system resource availability and/or specified performance (e.g., latency) constraint(s). Conversely, if resources are abundant and a higher accuracy is specified, the configuration selection model may select a larger, more complex configuration to maximize accuracy. As such, an optimized model configuration may be selected and executed on the fly (e.g., using a corresponding prune mask and precision flags).

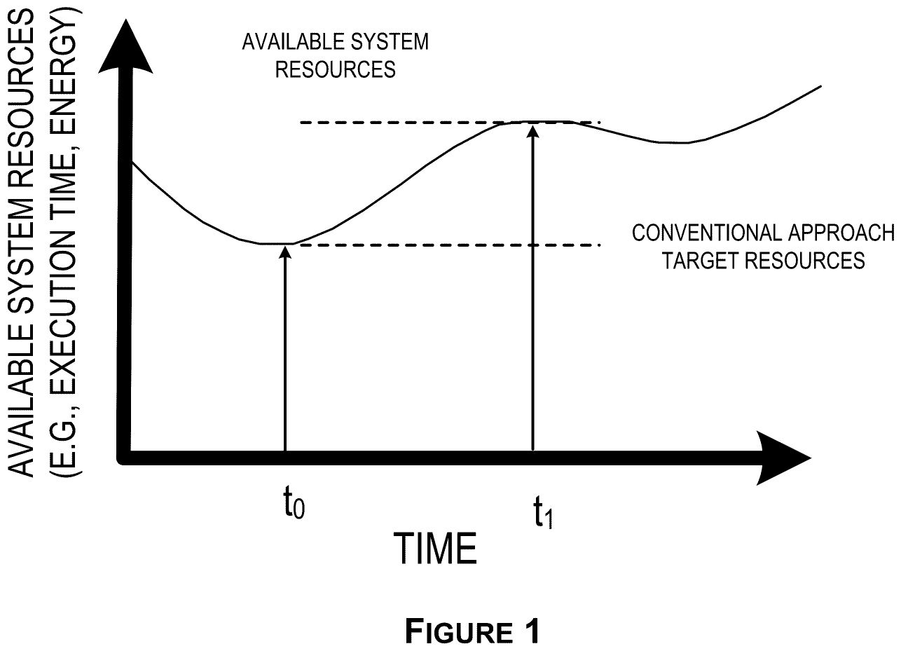

Accordingly, the techniques described herein may be used to predict future hardware availability and perform model scaling or optimization on the fly based on available (e.g., current, predicted future) hardware resources. The present techniques may be used to optimize accuracy within designated performance constraints (e.g., inference latency, power consumption) using the available hardware resources. Compared to prior techniques, the present techniques may be used to improve the real-time adaptability of model scaling or optimization based on available hardware resources and specified performance constraints, improving the balance between model performance and computational efficiency. For example, FIG. 1 illustrates possible fluctuations in available system resources. Whereas conventional techniques typically attempt to target their resource utilization at or below a lower bound of fluctuating availability, the present techniques facilitate a more fine-grained and efficient resource utilization that adapts to fluctuating availability.

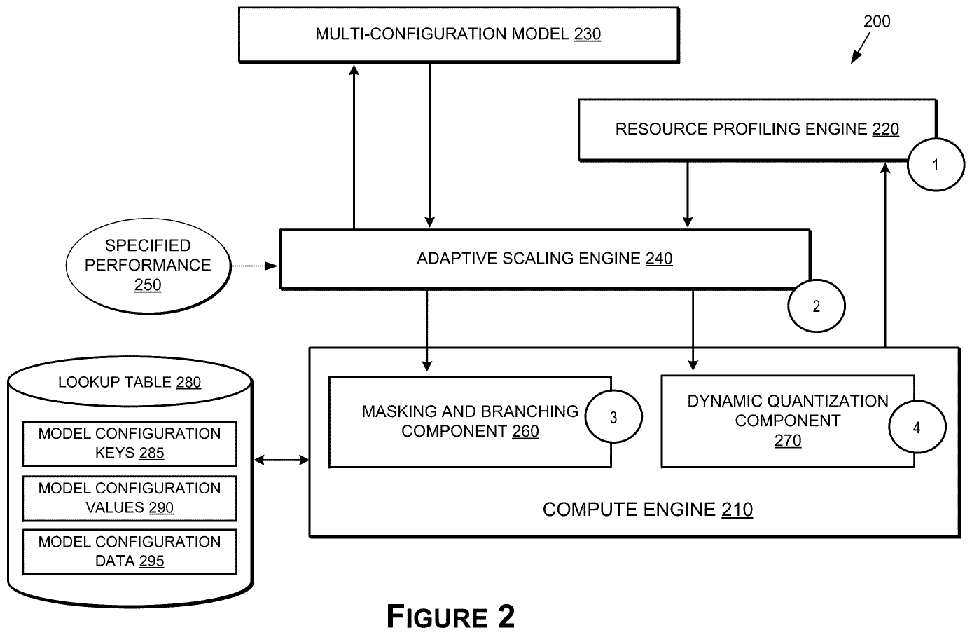

With reference to FIG. 2, FIG. 2 illustrates an example model adaptation system 200, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

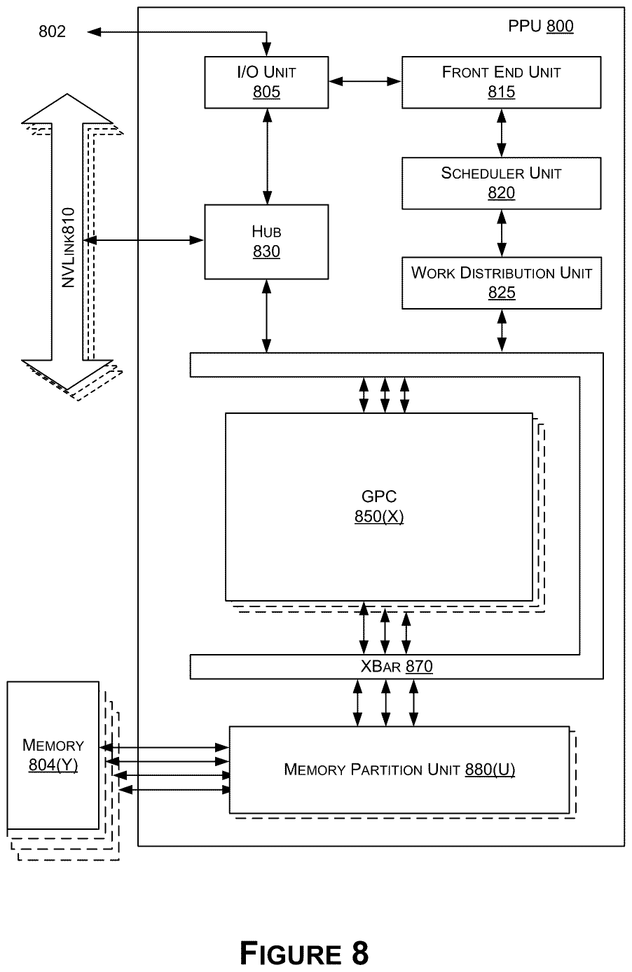

In FIG. 2, the model adaptation system 200 may be implemented on a device (e.g., a parallel processor (e.g., the PPU 800 of FIG. 8) such as a GPU), which may be optimized for parallel processing and high-performance tasks like matrix multiplications, AI operations, low-power operations, etc. For example, some or all of the components of the model adaptation system 200 may be implemented on an AI or deep learning accelerator such as a GPU with tensor cores (hardware units that accelerate matrix multiplications), an edge accelerator such as a GPU with internal or external specialized cores (e.g., tensor cores, digital signal processors (DSPs), dedicated hardware units tailored to specific AI operations like object detection or facial recognition, etc.) optimized for efficient or low-power inference at the edge, or some other processor(s).

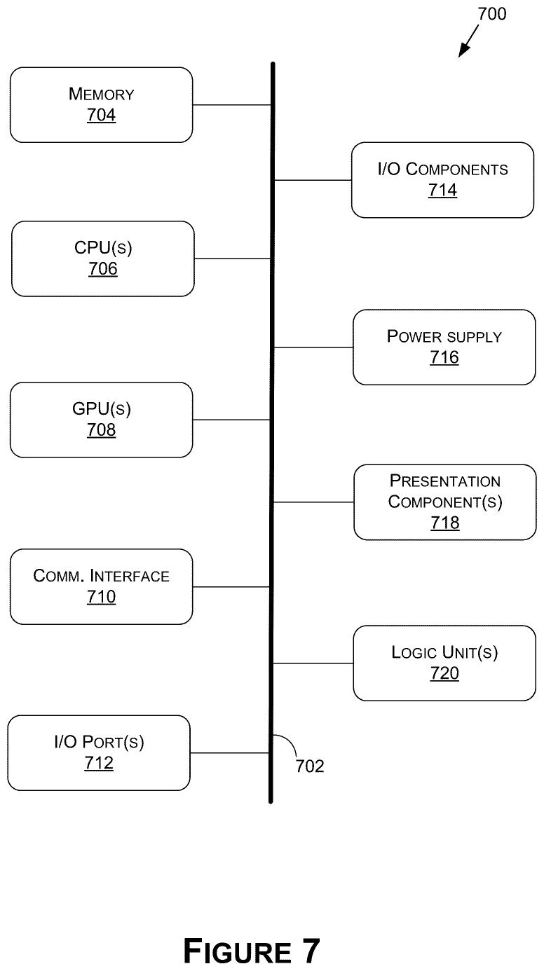

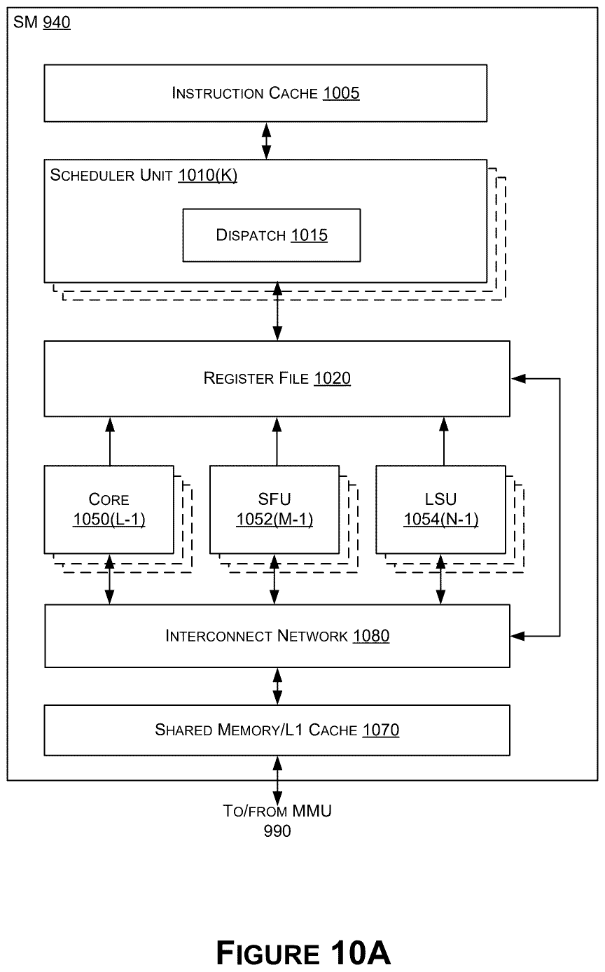

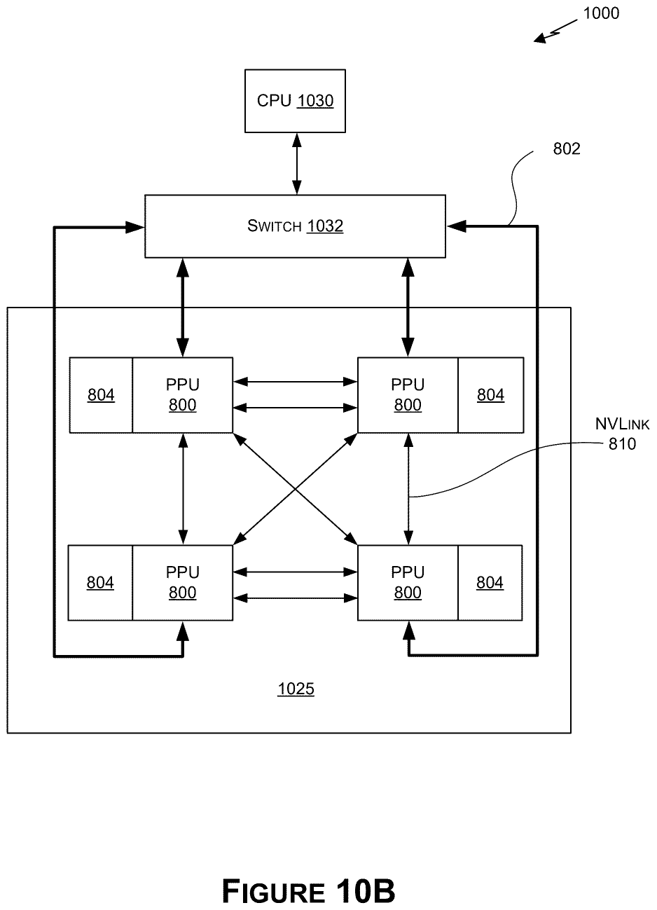

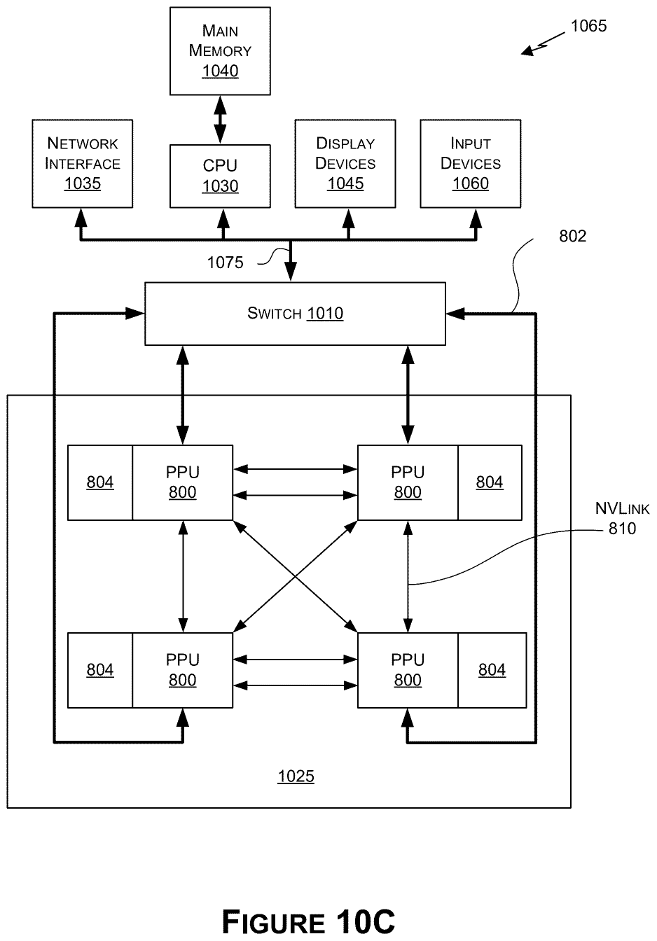

At a high level, the model adaptation system 200 may include a compute engine 210 (e.g., which may correspond to the logic unit(s) 720 of FIG. 7, the processing core(s) 1050 of FIG. 10, or the special function unit(s) 1052 of FIG. 10), and the compute engine 210 may execute one or more operations defined by a multi-configuration model 230. Execution of the operations may be instructed, orchestrated, or controlled, and input data may be identified, via an application executed by a host (not depicted in FIG. 1), such as a central processing unit (CPU) that runs application logic and coordinates task execution with (the device implementing) corresponding components of the model adaptation system 200. Generally, the model adaptation system 200 may dynamically adapt the multi-configuration model 230 while optimizing hardware efficiency and model performance (e.g., accuracy and latency) during inference based on available (current and/or predicted future) resources and a representation of specified target performance or performance constraints (e.g., specified performance 250). For example, the resource profiling engine 220 may generate a (e.g., current, predicted future) resource profile of the processor executing the multi-configuration model 230, the adaptive adaptation engine 240 may select a configuration of the multi-configuration model 230 optimized for the resource profile and the specified performance 250 and may instruct the compute engine 210 to switch to a corresponding configuration, and the compute engine 210 may dynamically adapt the multi-configuration model 230 by modifying the structure or parameters of the model during inference or runtime to correspond to the selected configuration. As such, the model adaptation system 200 may effectively scale, optimize, and/or compress the multi-configuration model 230 dynamically based on the specified performance 250 (e.g., latency, accuracy, power consumption, energy consumption) and the (e.g., current, predicted future) resource profile.

The multi-configuration model 230 may be generated with multiple possible configurations or operational modes by incorporating a representation of multiple configurations within the multi-configuration model 230, each of which may be tailored to a different resource profile (e.g., resource availability, occupancy, etc.) and/or different target performance metrics or performance constraints (e.g., accuracy, latency, power/energy consumption). As such, the multi-configuration model 230 may operate at various levels of complexities by selecting and switching to one of the configurations based on the resource profile and/or the specified performance 250.

There are different types of models that support multiple configurations for different levels of resource availability and/or performance. Taking a multi-configuration model 230 such as a multi-configuration neural network as an example, each configuration may represent a unique combination of architectural settings, such as the network's depth (e.g., number of layers), width (e.g., number of neurons per layer), kernel size, and/or input resolution. For example, a shallow, narrow configuration may prioritize low latency and energy efficiency, whereas a deeper, wider configuration may maximize accuracy when resource availability is higher. Taking a multi-configuration random forest as an example, each configuration may represent a unique combination of parameters such as the number of trees, the depth of each tree, and/or the number of features considered for splitting at each node. Increasing the number of trees often improves performance by reducing variance, but also typically increases computational cost. There are different types of multi-configuration image generation models, such as neural networks, ray-tracing systems, procedural generation systems, and evolutionary algorithms, and each configuration may represent a unique combination of parameters such as a target image resolution or number of iterations. For example, higher resolutions or more iterations may result in finer detail and more realistic output, but at the cost of increased computational cost.

As such, the multi-configuration model 230 may include multiple configurations or operating modes, which may be indexed (e.g., in a lookup table 280), retrieved, and executed based on the resource profile and/or the specified performance 250, as explained in more detail below.

To facilitate selection of an appropriate configuration of the multi-configuration model 230 optimized for the resource profile and the specified performance 250, the resource profiling engine 220 may generate a (e.g., current, predicted future) resource profile of the processor executing the multi-configuration model 230, and the adaptive scaling engine 240 may select a configuration of the multi-configuration model 230 optimized for the resource profile and the specified performance 250.

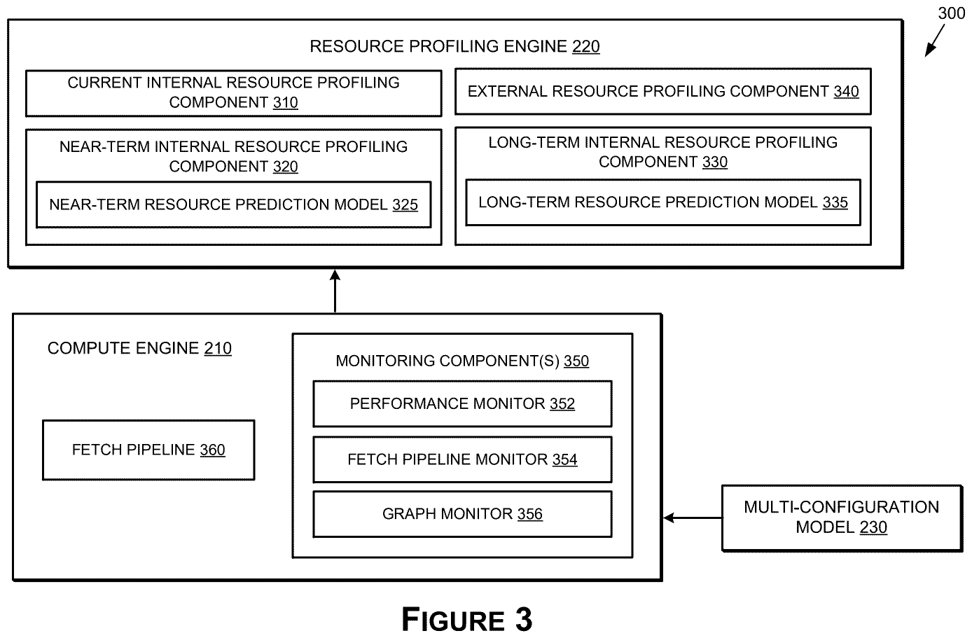

For example, FIG. 3 illustrates an example resource profiling system 300 with a resource profiling engine 220 (e.g., which may correspond to the resource profiling engine 220 of FIG. 2) and a compute engine 210 (e.g., which may correspond to the compute engine 210 of FIG. 2) of a processor executing a multi-configuration model 230 (e.g., which may correspond to the multi-configuration model 230 of FIG. 2). At a high level, the resource profiling engine 220 may generate a representation of a current and/or predicted future resource profile (representing one or more resource metrics that quantify or otherwise represent the occupancy, availability, performance potential, and/or actual output of one or more resources, such as compute resources, memory, memory bandwidth, power, energy, etc.) of the compute engine 210 running (or that will run) the multi-configuration model 230. The resource profiling engine 220 may perform one or more levels of monitoring and/or prediction to generate corresponding (e.g., current, near-term, long-term, external) resource profile(s) representing different points in time and may combine multiple levels of profiling to provide more accurate predictions.

Depending on the implementation, the resource profiling engine 220 may include a current internal resource profiling component 310, a near-term internal resource profiling component 320, a long-term internal resource profiling component 330, and/or an external resource profiling component 340. Moreover, the compute engine 210 may include or be associated with corresponding monitoring component(s) 350, such as a performance monitor 352, a fetch pipeline monitor 354, and/or a graph monitor 356. At a high level, the current internal resource profiling component 310 may interface with the performance monitor 352 to quantify or otherwise represent one or more aspects of a current internal resource profile of the compute engine 210 and/or the processor on which it executes. The near-term internal resource profiling component 320 may interface with the fetch pipeline monitor 354 to quantify pipeline activity data representing one or more aspects of the fetch pipeline 360 of the compute engine 210 and/or the processor on which it executes, and may predict a near-term internal resource profile of the compute engine 210 and/or the processor on which it executes. The long-term internal resource profiling component 330 may interface with the graph monitor 356 to analyze a computation graph representing an active or queued configuration of the multi-configuration model 230, and may predict a long-term internal resource profile of the compute engine 210 and/or the processor on which it executes. The current internal resource profiling component 310, the near-term internal resource profiling component 320, the long-term internal resource profiling component 330, and/or the external resource profiling component 340 may operate at any suitable rate or periodicity, whether regular or irregular, synchronized or unsynchronized, etc.

Depending on the implementation, the applicable components of the resource profiling engine 220 and/or the monitoring component(s) 350 may reside and execute in various locations. Taking an example device, any given component of the resource profiling engine 220 and/or the monitoring component(s) 350 may be implemented using native device code (e.g., built-in or configurable functions provided by the manufacturer of the device, which may be embedded within drivers, built-in libraries, firmware, etc.), using custom program(s) that may be written by a developer to execute specific tasks on the device, using program(s) included in hardware interface software associated with the device (e.g., a driver or firmware, whether on the host or the device), and/or using application code running on the host.

Taking estimation of a current resource profile of the compute engine 210 and/or the processor (e.g., a GPU, AI accelerator, etc.) on which it executes as an example, in some embodiments, the performance monitor 352 includes one or more mechanisms that estimate or measure metrics such as the clock frequency of the compute engine 210 (e.g., its core(s)), the power or energy being consumed in real-time, how much memory is being used and how much is free, utilization rates, throughput, cache hits, SM metrics (e.g., occupancy rate, warp execution efficiency, register or shared memory usage per SM, etc.), and/or otherwise. For example, the performance monitor 352 may include hardware counter(s) (e.g., performance counters for memory bandwidth, warp execution, cache hits); (e.g., firmware or driver) software that monitors, measures, or estimates sensor data (e.g., power, temperature); and/or interface software for querying performance metrics (e.g., via APIs). As such, the current internal resource profiling component 310 may interface with the performance monitor 352 to quantify or otherwise represent one or more aspects of the current internal resource profile of the compute engine 210 and/or the processor on which it executes, and may encode or otherwise generate a representation of the current internal resource profile using any known technique.

In some embodiments, the external resource profiling component 340 may include profiling functionality that interfaces with an external environment to quantify or otherwise represent one or more aspects of an external resource profile comprising one or more resource metrics that represent the occupancy, availability, performance potential, and/or actual output of resource(s) that exist outside the processor but may still influence its operation. For example, the processor running the compute engine 210 may be part of a system (e.g., a system with multiple processors that share task execution responsibilities), and the external resource profiling component 340 may interface with a monitoring component of that system to quantify or otherwise represent one or more aspects of the resource profile of that system, which may include a parameterization of a static configuration of the system (e.g., how many and/or what type of processors, GPUs, CPUs, processing cores, etc. the system has), a dynamic configuration or health status of the system (e.g., the number of available or unavailable processors, cores, SMs, etc.), a current load (e.g., of one or more processors or cores that share execution responsibilities with the processor running the compute engine 210, which may facilitate improved distribution of workloads across the processors or cores), a specified or predicted system characteristic(s) (e.g., an expected load pattern specified by a user or predicted by a model, such as periodic, daily, weekly, seasonal, or other temporal trends or variations in expected usage or load), a health status of a network environment in which the processor running the compute engine 210 is operating (e.g., a representation of the health of a node, cluster, or data center in which the processor is running the compute engine 210), and/or otherwise. As such, the external resource profiling component 340 may interface with the monitoring component(s) of the system that is external to the processor running the compute engine 210 to quantify or otherwise represent one or more aspects of the external resource profile of that system, and may encode or otherwise generate a representation of the external resource profile using any known technique.

As such, the near-term internal resource profiling component 320 and/or the long-term internal resource profiling component 330 may use the current internal resource profile, the external resource profile, and/or other information to predict a corresponding future resource profile, such as a near-term resource profile representing predicted near-term future resource conditions (e.g., at some relatively near-term future time or event, such as some number of inferences away) and/or a long-term resource profile representing predicted long-term future resource conditions (e.g., at some relatively farther away future time or event, such as some larger number of inferences away in the future).

In some embodiments, the near-term internal resource profiling component 320 may use a near-term resource prediction model 325 (e.g., a machine learning model such as a neural network, a look-up table) to estimate a near-term resource profile that quantifies one or more resource metrics representing an expected near-term occupancy, availability, performance potential, and/or actual output of one or more resources of the compute engine 210 and/or the processor on which it executes (e.g., compute occupancy or availability, memory occupancy or availability, memory bandwidth power or energy consumption, core frequency, throughput, etc.). For example, the near-term internal resource profiling component 320 may receive or look up a current internal resource profile generated by the current internal resource profiling component 320, may receive or look up an external resource profile generated by the external resource profiling component 340, and/or may interface with the fetch pipeline monitor 354 to generate pipeline activity data representing one or more aspects of the processor's fetch pipeline 360.

More specifically, the fetch pipeline 360 of the compute engine 210 may use any known technique to retrieve instructions from memory or instruction caches (I-cache), perform prefetching, and/or deliver the instructions to SMs or other hardware units, and the fetch pipeline monitor 354 may include one or more mechanisms that estimate or measure pipeline activity data representing one or more aspects of the fetch pipeline 360, such as detected types of instructions sent through the fetch pipeline 360 (e.g., detected from prefetch mechanisms, instruction caches (L1 I-cache), main memory), the number of queued instructions, the size of data moving through the fetch pipeline 360 (e.g., detected from data caches (e.g., L1 D-cache) or main memory), tracked performance indicators (e.g., missed fetches, stalls, latencies, throughput), and/or otherwise. For example, the fetch pipeline monitor 354 may include performance counters and/or tools for counting, tracking, and/or monitoring specific types of instructions (e.g., arithmetic, memory load/store, control flow), characteristics of data moving through the fetch pipeline 360, performance indicators, etc. As such, the near-term internal resource profiling component 320 may interface with the fetch pipeline monitor 354 to quantify, encode, or otherwise represent one or more aspects of the instruction and/or data flow through the fetch pipeline 360.

Accordingly, the near-term internal resource profiling component 320 may generate any suitable input representation of the current internal resource profile, the external resource profile, and/or the pipeline activity data, and may apply the input representation to the near-term resource prediction model 325 to generate a representation of a near-term internal resource profile parameterizing one or more resource metrics that represent an expected near-term occupancy, availability, performance potential, and/or actual output of one or more resources of the compute engine 210 and/or the processor on which it executes (e.g., compute occupancy or availability, memory occupancy or availability, memory bandwidth power or energy consumption, core frequency, throughput, etc.). Taking a simple example, certain types of instructions (e.g., memory fetches, tensor operations, activation functions, control flow instructions) and/or input data size may be predictive of one or more aspects of near-term resource occupancy, and the near-term resource prediction model 325 may be implemented using a look-up table that maps designated types of instructions and/or input data size to a corresponding estimated occupancy metric. In a more detailed example, the near-term internal resource profiling component 320 may encode any or all of the foregoing features using any known technique and apply the encoded features to a neural network trained to predict one or more aspects of near-term resource occupancy. These are just a few examples, and variations are contemplated within the scope of the present disclosure.

In some embodiments, the long-term internal resource profiling component 330 uses a long-term resource prediction model 335 (e.g., a machine learning model such as a neural network, a look-up table, a transformer) to estimate a long-term resource profile that quantifies one or more resource metrics representing an expected long-term occupancy, availability, performance potential, and/or actual output of one or more resources of the compute engine 210 and/or the processor on which it executes (e.g., compute occupancy or availability, memory occupancy or availability, memory bandwidth power or energy consumption, core frequency, throughput, etc.). For example, the long-term internal resource profiling component 330 may receive or look up a current internal resource profile generated by the current internal resource profiling component 320, may receive or look up an external resource profile generated by the external resource profiling component 340, and/or may interface with the graph monitor 356 to detect categories of computational graph operations present in an active or queued configuration of the multi-configuration model 230.

More specifically, an active or queued configuration of the multi-configuration model 230 may be compiled into a corresponding computational graph representing the operations (e.g., matrix multiplications, activation functions) and/or data dependencies of that configuration using any known technique, and the graph monitor 356 may parse the computational graph (e.g., by analyzing the graph in memory and/or by mapping compute activity to corresponding parts of the computational graph, etc.) to identify whether designated categories of operations are present (e.g., matrix multiplications, convolutions, activations, data movement, operations corresponding to a type of neural network layer, etc.). As such, the long-term internal resource profiling component 330 may interface with the graph monitor 356 to quantify, encode, or otherwise represent categories of computational graph operations detected in an active or queued configuration of the multi-configuration model 230.

As such, the long-term internal resource profiling component 330 may generate any suitable input representation of the current internal resource profile, the external resource profile, and/or the detected categories of computational graph operations, and may apply the input representation to the long-term resource prediction model 335 to generate a representation of a long-term internal resource profile parameterizing one or more resource metrics that represent an expected long-term occupancy, availability, performance potential, and/or actual output of one or more resources of the compute engine 210 and/or the processor on which it executes (e.g., compute occupancy or availability, memory occupancy or availability, memory bandwidth power or energy consumption, core frequency, throughput, etc.). In an example embodiment in which the long-term resource prediction model 335 is implemented using a transformer neural network, the long-term internal resource profiling component 330 may use the transformer neural network to encode the computation graph into a sequence of tokens and apply the encoded sequence of tokens to a neural network trained to predict one or more aspects of a long-term resource profile. In another example, the long-term resource prediction model 335 may be implemented using a look-up table that maps detected categories of computational graph operations a corresponding estimated occupancy metric. In a more detailed example, the long-term resource prediction model 335 may encode any or all of the foregoing features using any known technique and apply the encoded features to a neural network trained to predict one or more aspects of long-term resource occupancy. These are just a few examples, and variations are contemplated within the scope of the present disclosure.

As such and returning to FIG. 2, the resource profiling engine 220 may generate a resource profile quantifying, encoding, combining, or otherwise representing a current internal resource profile, a predicted near-term internal resource profile, a predicted long-term internal resource profile, and/or an external resource profile, and the adaptive scaling engine 240 may use the resource profile(s) generated by the resource profiling engine 220 and the specified performance 250 for the multi-configuration model 230 to select the best configuration of the multi-configuration model 230 to run.

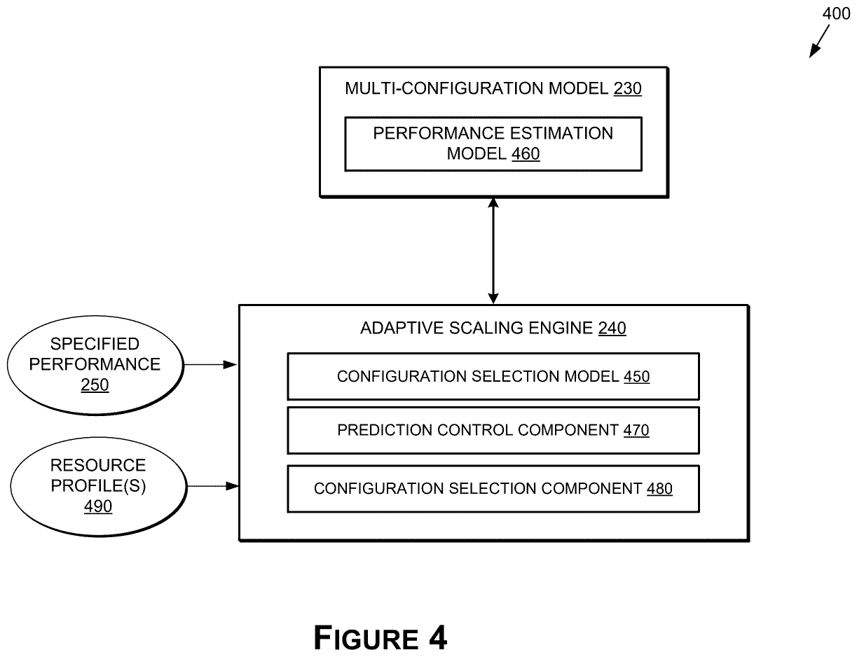

For example, FIG. 4 depicts an example adaptive scaling system 400 with an adaptive scaling engine 240 (e.g., which may correspond to the adaptive scaling engine 240 of FIG. 2) and a multi-configuration model 230 (e.g., which may correspond to the multi-configuration model 230 of FIG. 2). At a high level, the adaptive scaling engine 240 may use the resource profile(s) 490 (e.g., which may be generated by the resource profiling engine 220 of FIG. 2) and the specified performance 250 (e.g., which may correspond to the specified performance 250 of FIG. 2) to select an optimized configuration of the multi-configuration model 230 to run.

In some embodiments, the adaptive scaling engine 240 may use the resource profile(s) 490 (e.g., representing one or more resource metrics that quantify or otherwise represent the internal//external, current/near-term/long-term occupancy, availability, performance potential, and/or actual output of one or more resources, such as compute resources, memory, memory bandwidth, power consumption, energy consumption, and/or otherwise) and the specified performance 250 (e.g., one or more user or application specified target performance metrics or performance constraints, such as accuracy, latency, power consumption, energy consumption, etc.) to select a model configuration. More specifically, the adaptive scaling engine 240 may include a prediction control component 470 that periodically orchestrates predictions by a configuration selection model 450 and/or a performance estimation model 460, and may include a configuration selection component 480 that determines whether to switch model configurations based on the prediction results.

For example, the prediction control component 470 may accept the resource profile(s) 490 and the specified performance 250 as input, may use the resource profile(s) 490 and the specified performance 250 to quantify the expected performance of one or more of the model configurations (e.g., explicitly using the performance estimation model 460, implicitly in some embodiments in which the performance estimation model 460 is part of the configuration selection model 450), and may use the configuration selection model 450 to select a model configuration (e.g., based on the expected performance identified using the performance estimation model 460, based on the resource profile(s) 490, based on the specified performance 250).

For example, the multi-configuration model 230 may include or be associated with a performance estimation model 460 (e.g., implemented using a look up table, using any suitable machine learning model such as a neural network, etc.) that provides estimates of how each configuration will perform under certain conditions. In some embodiments, the performance estimation model 460 maps each model configuration or a representation of its architecture or complexity (e.g., depth, width, kernel size, resolution, number of trained parameters, etc.) and a specified resource profile (e.g., quantifying one or more resource metrics representing the occupancy, availability, performance potential, and/or actual output of one or more resources of the processor the model configuration is or will be executed on) to a measure of the estimated performance of the model configuration (e.g., latency, accuracy, energy consumption, power consumption, etc.) in the presence of that resource profile.

In some embodiments (e.g., with a finite number of configurations), the performance estimation model 460 may be implemented using a lookup table that maps each configuration (or a representation of its architecture or complexity) to a measure of its expected performance in the presence of a specified resource profile, such that the prediction control component 470 may look up the estimated or expected performance for any given configuration (e.g., each possible configuration) based on a specified resource profile (e.g., the resource profile(s) 490). In some embodiments, the performance of each configuration in the presence of various resource profiles may be characterized in advance, or may be filled in or updated during deployment (e.g., by the prediction control component 470 or some other component) using measured performance values. As such, the prediction control component 470 may use the performance estimation model 460 to look up the expected performance of one or more configurations (e.g., all possible configurations) based on the resource profile(s) 490, and may use the configuration selection model 450 to select a model configuration based on the expected performance(s) (as explained in more detail below).

In some embodiments, the performance estimation model 460 may be implemented using any suitable machine learning model (e.g., a neural network) trained to predict a measure of the estimated performance (e.g., latency, accuracy, energy consumption, power consumption, etc.) of one or more model configurations based on a specified resource profile (e.g., the resource profile(s) 490), or may use any other known function or method to estimate their cost. The performance estimation model 460 may accept input representing the architecture or complexity of a given model configuration (e.g., for neural networks, depth, width, kernel size, resolution, number of trained parameters, and/or other characteristics) and the resource profile(s) 490, and may output a representation of estimated performance (e.g., latency, accuracy, energy consumption, power consumption, etc.). During training or evaluation, performance data for various configurations may be collected by running them on target hardware and/or in the presence of different (e.g., measured, simulated) resource profiles, and the performance data may be used as ground truth training data to train the performance estimation model 460 to predict performance based on the architecture or complexity of the model configuration and the resource profile. In some embodiments, the performance estimation model 460 is part of the configuration selection model 450 such that the configuration selection model 450 implicitly estimates the performance of one or more model configurations.

Generally, the configuration selection model 450 may be implemented using any suitable machine learning model and/or any known selection algorithm (e.g., reinforcement learning, model predictive control, Bayesian optimization, etc.). Continuing with the example in which the prediction control component 470 uses the performance estimation model 460 to estimate the performance of one or more model configurations (implicitly or explicitly), the configuration selection model 450 may use any known reinforcement learning technique to learn a policy that uses the estimated performance (e.g., of all possible configurations), the specified performance 250, and/or the resource profile(s) 490 as part of its representation of the state of the system to select a model configuration that maximizes rewards based on some designated feedback (e.g., a measure of how well the selected configuration performs, how well it performs relative to the specified performance 250, how well it performs relative to the estimated performance, etc.). In some embodiments, the configuration selection model 450 uses any known model predictive control technique to select the model configuration (or generate a score or ranking for each configuration) using any known optimization technique that best maximizes a designated objective function that defines a goal (e.g., selecting a configuration that meets the specified performance 250, maximizes margin between the measured performance of the selected configuration and the specified performance 250, minimizes or maximizes resource usage, etc.). In some embodiments, the configuration selection model 450 uses any known Bayesian optimization technique to select the best model configuration (or generate a score or ranking for each configuration) using the estimated performance (e.g., of all possible configurations), the specified performance 250, and/or the resource profile(s) 490 as input to a designated acquisition function that identifies the configuration that maximizes a trade-off between exploiting high predicted performance and exploring uncertain estimates.

In some embodiments, the configuration selection model 450 implements a multi-class classifier (e.g., a machine learning model such as a neural network that supports classes corresponding to the parameters used to index the different configurations of the multi-configuration model 230 in the lookup table 280 of FIG. 2, classes that correspond to a number of indexed configurations of the multi-configuration model 230 in the lookup table 280 of FIG. 2, etc.), and the prediction control component 470 may use the specified performance 250 and the resource profile(s) 490 as input to predict the configuration that would achieve the best performance (e.g., generate a classification score or ranking for each configuration, regress a representation of a set of parameters that represent an optimized architecture or complexity, etc.) under corresponding conditions, constraints, and/or parameters.

In some embodiments, there may be multiple supported configuration selection models 450, and the prediction control component 470 may select one based on the specified performance 250 and/or the resource profile(s) 490. For example, one configuration selection model may optimize latency, one may optimize memory usage, one may minimize energy usage, etc. As such, the prediction control component 470 may determine whether the specified performance 250 prioritizes or corresponds to a category of performance associated with one of the supported configuration selection models 450, or whether providing the specified performance 250 in the presence of the resource profile(s) 490 would require or benefit from prioritizing a category of performance associated with one of the supported configuration selection models 450. For example, if the specified performance 250 identifies a target latency of 10-20 milliseconds and the resource profile(s) 490 identifies 12 milliseconds of available latency, the prediction control component 470 may compare the specified and available latency (or other resource metric), determine that a selected configuration will need to operate with 10-12 milliseconds of latency in order to meet the specified performance 250, and select and use a configuration selection model 450 that optimizes latency. These are just a few examples, and variations may be implemented within the present disclosure.

As such, the prediction control component 470 may determine when to initiate predictions (e.g., periodically, triggered by some event, etc.), select an applicable configuration selection model 450, and use the configuration selection model 450 (and/or the performance estimation model 460) to make predictions. Depending on the implementation, the configuration selection model 450 may make the selection itself (e.g., in embodiments in which the configuration selection model 450 uses reinforcement learning). In some embodiments (e.g., in embodiments in which the configuration selection model 450 uses model predictive control, Bayesian optimization, or a multi-class classifier), the configuration selection model 450 may generate scores or rankings for each possible configuration, and the configuration selection component 480 may select the configuration with the highest score or ranking, apply a designated threshold (e.g., only switching if the highest score or ranking exceeds a designated threshold), and/or otherwise. In some embodiments, the prediction control component 470 may initiate prediction of the estimated performance of a currently executing configuration of the multi-configuration model 230, and the configuration selection component 480 may compare the predicted performance to the specified performance 250 to determine whether the currently executing model configuration is predicted to comply. If so, the configuration selection component 480 may determine to continue using the current configuration. Otherwise, it may instruct the prediction control component 470 to test one or more alternate configurations, and may select one that satisfies the specified performance 250 (e.g., the first identified configuration predicted to satisfy the specified performance constraints, testing all supported configurations and selecting the one with the best predicted performance, etc.). The prediction control component 470 and/or configuration selection component 480 may operate at any suitable rate to evaluate and/or determine whether and when to switch to a different model configuration.

As such and returning to FIG. 2, the adaptive scaling engine 240 may identify one of the configurations of the multi-configuration modal 230 to switch to and instruct the compute engine 210 to switch to that configuration.

In some embodiments, each configuration of the multi-configuration model 230 may be represented or referenced in one or more data structures such as a lookup table 280, which may be indexed based on some representation of the architecture, complexity, and/or expected performance of the model configuration. For example, the different model configurations may be indexed using one or more model configuration keys 285 that identify the architecture, complexity, and/or expected performance of the model configuration, such as an index or ID of each model configuration; for neural networks, the depth, width, kernel size, resolution, number of trained parameters, and/or other characteristics of each model configuration; for random forests, the number of trees, the depth of each tree, the number of features considered for splitting at each node, and/or other characteristics of each model configuration; for image generation models, the target image resolution, number of iterations, and/or other characteristics of each model configuration; and/or a quantified representation of the expected performance of each model configuration (e.g., latency, accuracy, power consumption, energy consumption, etc.); to name a few possible examples. Each set of model configuration keys 285 may represent a supported configuration of the multi-configuration model 230, and the sets of model configuration keys 285 in the lookup table 280 may be associated with corresponding model configuration values 290 that represent, encode, reference, or otherwise identify the corresponding model configuration and/or model configuration data 295 representing the corresponding model configuration. For example, the lookup table 280 may use model hashes for the supported model configurations as the model configuration values 290, such that the model configuration keys 285 may be used to lookup a corresponding model hash, and the model hash may be decoded, expanded, or used to lookup or otherwise identify corresponding model configuration data 295, such as a representation of the architecture of the configuration, a model prune mask (e.g., identifying block(s), layer(s), channel(s), neuron(s), and/or other features to be removed from the model architecture for the configuration), precision flag(s) (e.g., specifying the numerical precision to be used in computations corresponding to components of the model such as blocks, layers, or channels for the configuration), and/or other characteristics. These are meant simply as examples, and variations may be implemented within the scope of the present disclosure.

The adaptive scaling engine 240 may coordinate with the compute engine 210 to switch to a selected configuration of the multi-configuration model 230 in various ways. For example, the adaptive scaling engine 240 may provide the compute engine 210 with some representation of the selected configuration (e.g., one or more of the model configuration keys 285 identifying an entry in the lookup table 280), and the compute engine 210 may use the model configuration keys 285 to look up the corresponding model configuration value 290 (e.g., a corresponding model has) and/or corresponding model configuration data 295 (e.g., model prune mask, precision flag(s), etc.). In some embodiments, the adaptive scaling engine 240 uses the model configuration keys 285 to look up the corresponding model configuration value 290 (e.g., a corresponding model hash) and/or corresponding model configuration data 295 (e.g., model prune mask, precision flag(s), etc.) and provide the model configuration data 295 to the compute engine 210, or the adaptive scaling engine 240 may provide the model configuration value 290 to the compute engine 210 and the compute engine 210 may look up the corresponding model configuration data 295. These are just a few examples, and variations may be implemented within the present disclosure.

As such, the compute engine 210 may run a corresponding model configuration using the model configuration data 295 (e.g., the associated pruning mask and/or precision flags) to optimize and dynamically scale or optimize the multi-configuration model 230 on the fly. For example, the compute engine 210 may include a masking and branching component 260 that prunes the multi-configuration model 230 using the pruning mask and/or a dynamic quantization component 270 that reduces the precision of computations using the precision flags.

For example, a model prune mask for an identified configuration may be implemented using one or more data structures (e.g., a binary tensor) that indicate which parts of the model (e.g., neural network) should remain active and which should be pruned, and the masking and branching component 260 may use the prune mask during execution to mask, deactivate, bypass, or skip components identified by the prune mask in order to reduce computational load, memory usage, and inference time. In some embodiments, the masking and branching component 260 uses hardware-aware latency pruning to remove parts of the model (e.g., weights or neurons) and reduce latency based on hardware constraints and/or Hessian-aware compression to identify and remove less important parameters while minimizing the impact on accuracy. Additionally or alternatively, the masking and branching component 260 may use any known branching technique such as hardware-friendly alternative paths (Leaf) to create adaptive pathways or configurations tailored to specific input or runtime conditions. The masking and branching component 260 may use techniques such as group masking and/or branch fusion to address irregular execution (e.g., when computational tasks are unevenly distributed across hardware) and/or branch divergence (e.g., when different execution threads follow different branches). As such, these techniques may be used to increase computational efficiency, improve adaptability, and reduce latency during runtime, thereby addressing the challenges posed by fluctuating runtime constraints, which may be beneficial in resource-constrained environments and real-time applications.

Precision flags (or some other suitable data structure(s)) for an identified configuration may specify the numerical precision to be used in computations for various components of the model configuration, such as blocks, layers, or channels. Precision flags may be beneficial in mixed-precision training or inference, where different parts of a model operate at different levels of numerical precision (e.g., 16-bit floating point, 32-bit floating point, 8-bit integer, etc.). As such, the dynamic quantization component 270 may use the precision flags to implement any known quantization technique during runtime to address the challenges posed by fluctuating runtime constraints, significantly reducing memory consumption, accelerating inference, and minimizing accuracy loss, making it beneficial for resource-constrained devices. Dynamic quantization may be used for various architectures and requires no additional training, making it a practical solution for deploying efficient deep learning models. To further enhance efficiency, the dynamic quantization component 270 may employ quantization near memory (QN-RAM) and/or quantization near compute (QN-Compute) techniques. QN-RAM performs quantization directly within the memory subsystem, minimizing data movement, whereas QN-Compute quantizes within the compute engine 210, improving cache utilization and reducing memory bandwidth requirements. These optimizations enable faster and more energy-efficient inference on various hardware platforms.

As such, the compute engine 210 may switch model configurations on the fly during execution or inference to dynamically scale or optimize the multi-configuration model 230 in response to fluctuating runtime constraints, thereby adapting the computational process (e.g., of a neural network or other type of multi-configuration model 230) to optimize speed, memory, power, and/or energy efficiency while maintaining accuracy.

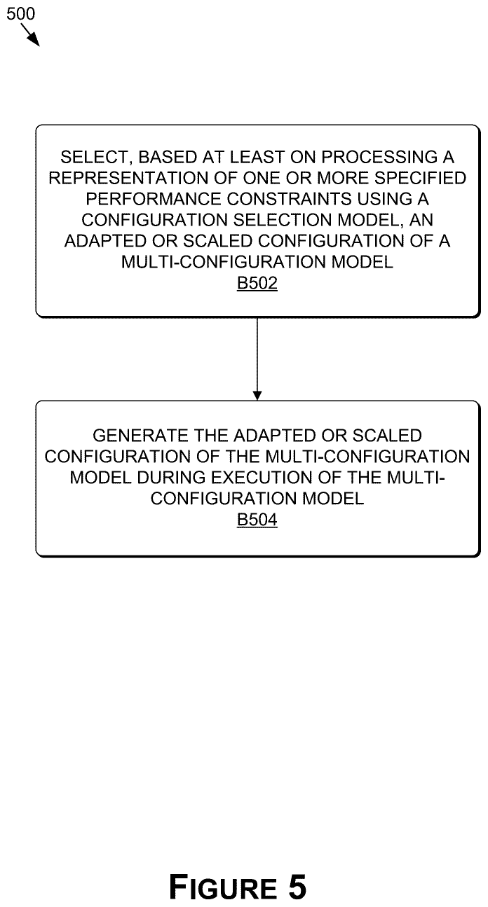

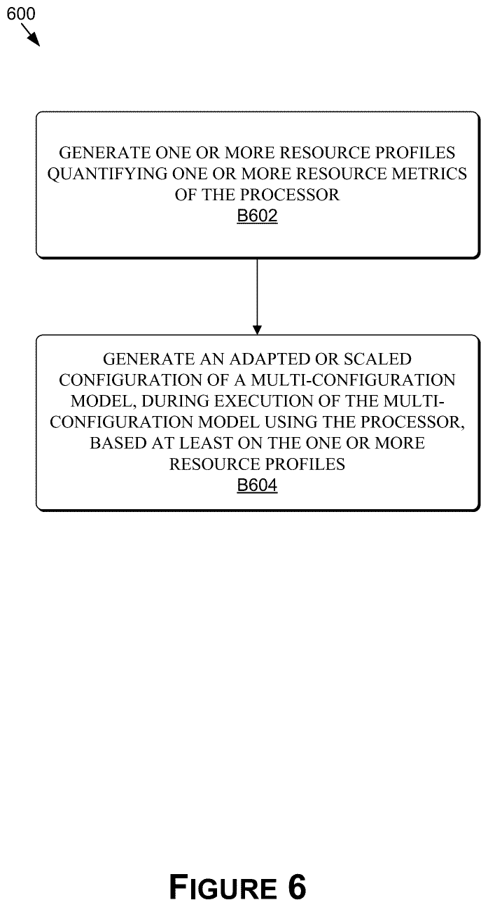

Now referring to FIGS. 5 and 6, each block of the methods 500 and 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a standalone service, a hosted service (standalone or in combination with another hosted service), or a plug-in to another product, to name a few. In addition, the methods 500 and 600 are described, by way of example, with respect to the model adaptation system 200 of FIG. 2 and the adaptive scaling system 400 of FIG. 4. However, these methods may additionally or alternatively be executed by any one system, or any combination of systems, including, but not limited to, those described herein.

FIG. 5 is a flow diagram showing a method 500 for generating an adapted or scaled configuration of a multi-configuration model selected using a configuration selection model, in accordance with some embodiments of the present disclosure. The method 500, at block B502, includes selecting, based at least on processing a representation of one or more specified performance constraints using a configuration selection model, an adapted or scaled configuration of a multi-configuration model. For example, with respect to the adaptive scaling system 400 of FIG. 4, the configuration selection model 450 may use any known reinforcement learning technique to learn a policy that uses the estimated performance (e.g., of all possible configurations), the specified performance 250, and/or the resource profile(s) 490 as part of its representation of the state of the system to select a model configuration that maximizes rewards based on feedback (e.g., some measure of how well the selected configuration performs, how well it performs relative to the specified performance 250, how well it performs relative to the estimated performance, etc.). In some embodiments, the configuration selection model 450 uses any known model predictive control technique to select the best model configuration (or generate a score or ranking for each configuration) using any known optimization technique to maximize an objective function that defines a goal (e.g., selecting a configuration that meets the specified performance 250, maximizes margin between the measured performance of the selected configuration and the specified performance 250, minimizes or maximizes resource usage, etc.). In some embodiments, the configuration selection model 450 uses any known Bayesian optimization technique to select the best model configuration (or generate a score or ranking for each configuration) using the estimated performance (e.g., of all possible configurations), the specified performance 250, and/or the resource profile(s) 490 as input to an acquisition function that identifies the configuration that maximizes a trade-off between exploiting high predicted performance and exploring uncertain estimates.

The method 500, at block B504, includes generating the adapted or scaled configuration of the multi-configuration model during execution of the multi-configuration model. For example, with respect to the model adaptation system 200 of FIG. 2, the adaptive scaling engine 240 may coordinate with the compute engine 210 to switch to a selected configuration of the multi-configuration model 230, and the compute engine 210 may run a corresponding model configuration using the model configuration data 295 (e.g., the associated pruning mask and/or precision flags) to optimize and dynamically scale or optimize the multi-configuration model 230 on the fly. For example, the compute engine 210 may include a masking and branching component 260 that prunes the multi-configuration model 230 using the pruning mask and/or a dynamic quantization component 270 that reduces the precision of computations using the precision flags. As such, the compute engine 210 may switch model configurations on the fly during execution or inference, dynamically scaling or optimizing the multi-configuration model 230 in response to fluctuating runtime constraints, thereby adapting the computational process (e.g., of a neural network or other type of multi-configuration model 230) to optimize speed, memory, power, and/or energy efficiency while maintaining accuracy.

FIG. 6 is a flow diagram showing a method 600 for generating an adapted or scaled configuration of a multi-configuration model based at least on one or more resource profiles, in accordance with some embodiments of the present disclosure. The method 600, at block B602, includes generating one or more resource profiles quantifying one or more resource metrics of the processor. For example, with respect to the model adaptation system 200 of FIG. 2, the resource profiling engine 220 may perform one or more levels of monitoring and/or prediction to generate corresponding (e.g., current, near-term, long-term, external) resource profile(s) representing different points in time, and may combine multiple levels of profiling to provide more accurate predictions.

The method 600, at block B604, includes generating an adapted or scaled configuration of a multi-configuration model, during execution of the multi-configuration model using the processor, based at least on the one or more resource profiles. For example, with respect to the model adaptation system 200 of FIG. 2 and the adaptive scaling system 400 of FIG. 4, the adaptive scaling engine 240 may use the resource profile(s) 490 (e.g., which may be generated by the resource profiling engine 220 of FIG. 2) and the specified performance 250 (e.g., which may correspond to the specified performance 250 of FIG. 2) to select an optimized configuration of the multi-configuration model 230 to run, the adaptive scaling engine 240 may instruct the compute engine 210 to switch to a selected configuration of the multi-configuration model 230, and the compute engine 210 may run a corresponding model configuration using the model configuration data 295 (e.g., the associated pruning mask and/or precision flags) to optimize and dynamically scale or optimize the multi-configuration model 230 on the fly.

### Example Applications

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), generative AI applications, language model applications (e.g., large language models (LLMs), vision language models (VLMs), etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems for performing generative AI operations, systems implemented at least partially in a data center, systems for performing conversational AI operations, systems implementing one or more language models—such as one or more large language models (LLMs), one or more vision language models (VLMs), one or more multi-modal language models, etc., systems for hosting real-time streaming applications, system for presenting one or more of virtual reality content, augmented reality content, or mixed reality content,, systems for performing light transport simulation, systems for performing collaborative content creation for 3D assets, systems implemented at least partially using cloud computing resources, and/or other types of systems.

In some embodiments, the present techniques may be used to support a simulation. For example, a simulation and/or neural network may be used to create simulated datasets that replicate various real-world conditions (e.g., that may be difficult or dangerous to observe in the real world), and/or training or validating a neural network or classical machine learning model within a simulation may expose these models to a range of (e.g., rare or dangerous) scenarios in a controlled and safe environment. As such, in some embodiments, one or more simulated agents may be controlled within a simulation environment (e.g., NVIDIA's DriveSIM, NVIDIA's ISAAC GYM, NVIDIA's ISAAC SIM, etc.) based on outputs of a multi-configuration model evaluating simulated data (e.g., simulated sensor data of simulated sensors of a virtual or simulated machine). For example, simulated sensor data may be processed using a selected configuration of one or more multi-configuration models to generate one or more outputs, which may be used to perform operations (e.g., control, navigation, planning, etc. operations) associated with the virtual machine within the environment. These simulated operations may be used to test performance of the underlying algorithms, systems, and/or processes prior to deploying them in the real-world. In some instances, the simulation may be used to generate synthetic training data—e.g., training data including regions of interest and/or sub-regions of interest from within the simulation. In some embodiments, other methods may be used in addition or alternatively from a simulation to generate synthetic training data. For example, the synthetic training data may be generated using neural rendering fields (NERFs), Gaussian splat techniques, diffusion models, electrostatic models (e.g., Poisson flow generative models (PFGMs), etc. The synthetic training data (in addition to or alternatively from real-world data) may then be processed to determine geometry, curvature, semantic information, classification information, and/or other information related to features of interest, such as lines, longitudinal features (e.g., poles), and/or other features within a driving environment, a warehouse, etc., for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing a multi-configuration model, image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with machine learning model(s) (e.g., language model, LLM, VLM, MMLM, diffusion model, transformer model, NeRF, DNN, multi-configuration models, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing a multi-configuration game model, game assets, player data, etc.). These devices may use one or more machine learning models (e.g., diffusion models, transformer models, neural rendering field (NeRF) models, language models (e.g., LLMs, VLMs, MMLMs, etc.), DNNs, multi-configuration models, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the (e.g., multi-configuration) machine learning model(s) and/or visual rendering may occur on one or more remotely located servers/computing devices (e.g., in one or more data centers). A language model, AI processing, and/or rendering may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.), multi-configuration models) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models such as multi-configuration models). The robotic system may use these processors to execute one or more machine learning models (e.g., language models, multi-configuration models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized (e.g., multi-configuration) AI models can analyze and distribute optimized commands to an entire fleet. In some embodiments, the machine learning model(s) (e.g., language models, VLMs, LLMs, MMLMs, diffusion models, NeRF models, DNNs, multi-configuration models, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models such as multi-configuration models). And memory and/or storage (e.g., for storing entertainment content, navigation data, and user preferences). The system may use these processors to execute one or more machine learning models (e.g., language models, multi-configuration models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models (e.g., multi-configuration models) may be stored locally or accessed through one or more APIs that connect to cloud services, enabling the system to process requests in real time or near real-time.

In some embodiments, one or more transformer engines (Tes) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the Tes may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

### Machine Learning

Deep neural networks (DNNs) and other machine learning models have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system may be trained in object recognition and classification to identify objects and classify those objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features may be assigned a certain weight based on the importance of that feature in defining the shape of an object.

A DNN model typically includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer may assemble the lines to look for higher level patterns such as wheels, windshields, and mirrors. The next layer may identify a type of vehicle, and the final few layers may generate a label for the input image, identifying the model of a specific automobile brand.

Once the DNN is trained, it may be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label may be analyzed, and the weights may be adjusted for each feature during a backward propagation phase until the DNN correctly labels the input and other inputs in a training dataset. Training complex neural networks requires massive amounts of parallel computing performance, including floating-point multiplications and additions that may be supported by the PPU 800.

Whether during training, testing, or inference, neural networks rely heavily on matrix math operations, and complex multi-layered networks require tremendous amounts of floating-point performance and bandwidth for both efficiency and speed. In some embodiments (e.g., with thousands of processing cores, optimized for matrix math operations, delivering tens to hundreds of TFLOPS of performance), the PPU 800 may be a computing platform capable of supporting deep neural network-based artificial intelligence and machine learning applications.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706) and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Parallel Processing Architecture

FIG. 8 illustrates a parallel processing unit (PPU) 800, in accordance with an embodiment. In an embodiment, the PPU 800 is a multi-threaded processor that is implemented on one or more integrated circuit devices. The PPU 800 is a latency hiding architecture designed to process many threads in parallel. A thread (e.g., a thread of execution) is an instantiation of a set of instructions configured to be executed by the PPU 800. In an embodiment, the PPU 800 is a graphics processing unit (GPU) configured to implement a graphics rendering pipeline for processing three-dimensional (3D) graphics data in order to generate two-dimensional (2D) image data for display on a display device such as a liquid crystal display (LCD) device. Additionally or alternatively, the PPU 800 may be utilized for general-purpose computations. While certain embodiments focus on features of the example parallel processing unit described herein, this is meant simply as an example, and other processors may be implemented within the scope of the present disclosure.

One or more instances of the PPU 800 may be configured to accelerate thousands of High-Performance Computing (HPC), data center, and/or machine learning applications. The PPU 800 may be configured to accelerate numerous deep learning systems and/or other applications, such as autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, to name a few examples.

As shown in FIG. 8, the PPU 800 includes an Input/Output (I/O) unit 805, a front-end unit 815, a scheduler unit 820, a work distribution unit 825, a hub 830, a crossbar (Xbar) 870, one or more general processing clusters (GPCs) 850, and one or more partition units 880. The PPU 800 may be connected to a host processor or other PPUs 800 via one or more high-speed NVLink 810 interconnect. The PPU 800 may be connected to a host processor or other peripheral devices via an interconnect 802. The PPU 800 may also be connected to a local memory comprising any number of memory devices (e.g., memory 804). In an embodiment, the local memory may comprise a number of dynamic random-access memory (DRAM) devices. The DRAM devices may be configured as a high-bandwidth memory (HBM) subsystem, with multiple DRAM dies stacked within each device.

The NVLink 810 interconnect enables systems to scale and include one or more PPUs 800 combined with one or more CPUs, supports cache coherence between the PPUs 800 and CPUs, and CPU mastering. Data and/or commands may be transmitted by the NVLink 810 through the hub 830 to/from other units of the PPU 800 such as one or more copy engines, a video encoder, a video decoder, a power management unit, etc. (not explicitly shown). The NVLink 810 is described in more detail in conjunction with FIG. 10B.

The I/O unit 805 is configured to transmit and receive communications (e.g., commands, data, etc.) from a host processor (not shown) over the interconnect 802. The I/O unit 805 may communicate with the host processor directly via the interconnect 802 and/or through one or more intermediate devices such as a memory bridge. In an embodiment, the I/O unit 805 may communicate with one or more other processors such as one or more PPUs 800 via the interconnect 802. In an embodiment, the I/O unit 805 implements a Peripheral Component Interconnect Express (PCIe) interface for communications over a PCIe bus and the interconnect 802 is a PCIe bus. In alternative embodiments, the I/O unit 805 may implement other types of well-known interfaces for communicating with external devices.

The I/O unit 805 decodes packets received via the interconnect 802. In an embodiment, the packets represent commands configured to cause the PPU 800 to perform various operations. The I/O unit 805 transmits the decoded commands to various other units of the PPU 800 as the commands may specify. For example, some commands may be transmitted to the front-end unit 815. Other commands may additionally or alternatively be transmitted to the hub 830 or other units of the PPU 800 such as one or more copy engines, a video encoder, a video decoder, a power management unit, etc. (not explicitly shown). In other words, the I/O unit 805 may route communications between and among the various logical units of the PPU 800.

In an embodiment, a program executed by the host processor may encode a command stream in a buffer that provides workloads to the PPU 800 for processing. A workload may comprise several instructions and data to be processed by those instructions. The buffer is a region in a memory that is accessible (e.g., read/write) by both the host processor and the PPU 800. For example, the I/O unit 805 may be configured to access the buffer in a system memory connected to the interconnect 802 via memory requests transmitted over the interconnect 802. In an embodiment, the host processor writes the command stream to the buffer and then transmits a pointer to the start of the command stream to the PPU 800. The front-end unit 815 may receive pointers to one or more command streams. As such, the front-end unit 815 may manage the one or more streams, reading commands from the streams and forwarding commands to the various units of the PPU 800.

The front-end unit 815 may be coupled to a scheduler unit 820 that configures the various GPCs 850 to process tasks defined by the one or more streams. The scheduler unit 820 is configured to track state information related to the various tasks managed by the scheduler unit 820. The state may indicate which GPC 850 a task is assigned to, whether the task is active or inactive, a priority level associated with the task, and so forth. The scheduler unit 820 manages the execution of a plurality of tasks on the one or more GPCs 850.

Continuing with the embodiment illustrated in FIG. 8, the scheduler unit 820 may be coupled to a work distribution unit 825 that is configured to dispatch tasks for execution on the GPCs 850. The work distribution unit 825 may track a number of scheduled tasks received from the scheduler unit 820. In an embodiment, the work distribution unit 825 manages a pending task pool and an active task pool for each of the GPCs 850. The pending task pool may comprise a number of slots (e.g., 32 slots) that contain tasks assigned to be processed by a particular GPC 850. The active task pool may comprise a number of slots (e.g., 4 slots) for tasks that are actively being processed by the GPCs 850. As a GPC 850 finishes the execution of a task, that task may be evicted from the active task pool for the GPC 850 and one of the other tasks from the pending task pool may be selected and scheduled for execution on the GPC 850. If an active task has been idle on the GPC 850, such as while waiting for a data dependency to be resolved, then the active task may be evicted from the GPC 850 and returned to the pending task pool while another task in the pending task pool is selected and scheduled for execution on the GPC 850.

The work distribution unit 825 may communicate with the one or more GPCs 850 via Xbar 870. The Xbar 870 may comprise an interconnect network that couples many of the units of the PPU 800 to other units of the PPU 800. For example, the Xbar 870 may be configured to couple the work distribution unit 825 to a particular GPC 850. Although not shown explicitly, one or more other units of the PPU 800 may also be connected to the Xbar 870 via the hub 830.

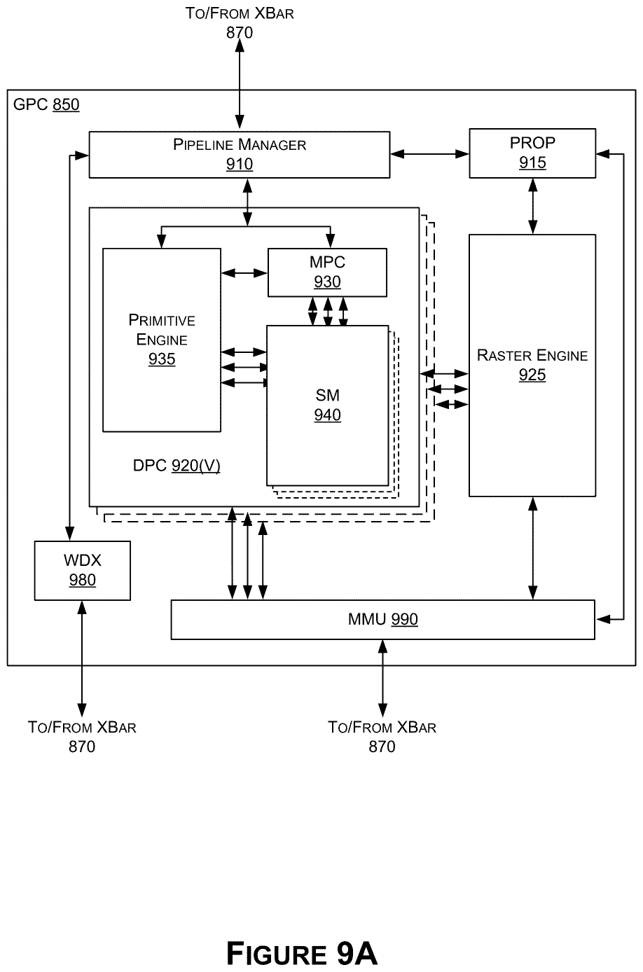

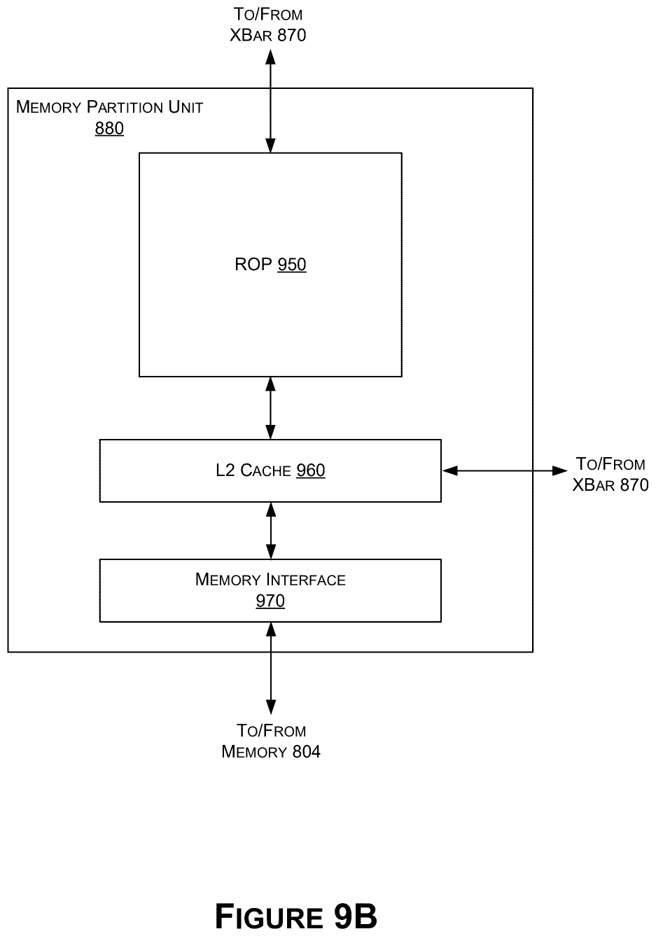

The tasks may be managed by the scheduler unit 820 and dispatched to a GPC 850 by the work distribution unit 825. The GPC 850 may be configured to process the tasks and generate results. The results may be consumed by other tasks within the GPC 850, routed to a different GPC 850 via the Xbar 870, or stored in the memory 804. The results may be written to the memory 804 via the partition units 880, which may implement a memory interface for reading and writing data to/from the memory 804. The results may be transmitted to another PPU 800 or CPU via the NVLink 810. In an embodiment, the PPU 800 includes a number U of partition units 880 that is equal to the number of separate and distinct memory 804 devices coupled to the PPU 800. A partition unit 880 will be described in more detail in conjunction with FIG. 9B.

In an embodiment, a host processor executes a driver kernel that implements an application programming interface (API) that enables one or more applications executing on the host processor to schedule operations for execution on the PPU 800. In an embodiment, multiple compute applications are simultaneously executed by the PPU 800 and the PPU 800 provides isolation, quality of service (QoS), and independent address spaces for the multiple compute applications. An application may generate instructions (e.g., API calls) that cause the driver kernel to generate one or more tasks for execution by the PPU 800. The driver kernel may output tasks to one or more streams being processed by the PPU 800. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 10A.

FIG. 9A illustrates a GPC 850 of the PPU 800 of FIG. 8, in accordance with an embodiment. As shown in FIG. 9A, each GPC 850 includes a number of hardware units for processing tasks. In an embodiment, each GPC 850 includes a pipeline manager 910, a pre-raster operations unit (PROP) 915, a raster engine 925, a work distribution crossbar (WDX) 980, a memory management unit (MMU) 990, and one or more Data Processing Clusters (DPCs) 920. It will be appreciated that the GPC 850 of FIG. 9A may include other hardware units in lieu of or in addition to the units shown in FIG. 9A.

In an embodiment, the operation of the GPC 850 is controlled by the pipeline manager 910. The pipeline manager 910 manages the configuration of the one or more DPCs 920 for processing tasks allocated to the GPC 850. In an embodiment, the pipeline manager 910 may configure at least one of the one or more DPCs 920 to implement at least a portion of a graphics rendering pipeline. For example, a DPC 920 may be configured to execute a vertex shader program on the programmable streaming multiprocessor (SM) 940. The pipeline manager 910 may also be configured to route packets received from the work distribution unit 825 to the appropriate logical units within the GPC 850. For example, some packets may be routed to fixed function hardware units in the PROP 915 and/or raster engine 925 while other packets may be routed to the DPCs 920 for processing by the primitive engine 935 or the SM 940. In an embodiment, the pipeline manager 910 may configure at least one of the one or more DPCs 920 to implement a neural network model and/or a computing pipeline.

The PROP unit 915 may be configured to route data generated by the raster engine 925 and the DPCs 920 to a Raster Operations (ROP) unit, described in more detail in conjunction with FIG. 9B. In some embodiments, the PROP unit 915 is configured to perform optimizations for color blending, organize pixel data, perform address translations, and/or other tasks.

The raster engine 925 includes a number of fixed function hardware units configured to perform various raster operations. In an embodiment, the raster engine 925 includes a setup engine, a coarse raster engine, a culling engine, a clipping engine, a fine raster engine, and/or a tile coalescing engine. The setup engine may receive transformed vertices and generate plane equations associated with the geometric primitive defined by the vertices. The plane equations may be transmitted to the coarse raster engine to generate coverage information (e.g., an x,y coverage mask for a tile) for the primitive. The output of the coarse raster engine may be transmitted to the culling engine where fragments associated with the primitive that fail a z-test may be culled, and transmitted to a clipping engine where fragments lying outside a viewing frustum may be clipped. Those fragments that survive clipping and culling may be passed to the fine raster engine to generate attributes for the pixel fragments based on the plane equations generated by the setup engine. The output of the raster engine 925 may comprise fragments to be processed, for example, by a fragment shader implemented within a DPC 920.

Each DPC 920 included in the GPC 850 may include an M-Pipe Controller (MPC) 930, a primitive engine 935, and one or more SMs 940. The MPC 930 may control the operation of the DPC 920, routing packets received from the pipeline manager 910 to the appropriate units in the DPC 920. For example, packets associated with a vertex may be routed to the primitive engine 935, which may be configured to fetch vertex attributes associated with the vertex from the memory 804. In contrast, packets associated with a shader program may be transmitted to the SM 940.

The SM 940 comprises a programmable streaming processor that is configured to process tasks represented by a number of threads. Each SM 940 is multi-threaded and configured to execute a plurality of threads (e.g., 32 threads) from a particular group of threads concurrently. In an embodiment, the SM 940 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 940 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 940 will be described in more detail below in conjunction with FIG. 10A.

The MMU 990 provides an interface between the GPC 850 and the partition unit 880. The MMU 990 may provide translation of virtual addresses into physical addresses, memory protection, and arbitration of memory requests. In an embodiment, the MMU 990 provides one or more translation lookaside buffers (TLBs) for performing translation of virtual addresses into physical addresses in the memory 804.

FIG. 9B illustrates a memory partition unit 880 of the PPU 800 of FIG. 8, in accordance with an embodiment. As shown in FIG. 9B, the memory partition unit 880 includes a Raster Operations (ROP) unit 950, a level two (L2) cache 960, and a memory interface 970. The memory interface 970 is coupled to the memory 804. Memory interface 970 may implement 32, 64, 128, 1024-bit data buses, or other types of data buses, for high-speed data transfer. In an embodiment, the PPU 800 incorporates U memory interfaces 970, one memory interface 970 per pair of partition units 880, where each pair of partition units 880 is connected to a corresponding memory device (e.g., memory 804). For example, PPU 800 may be connected to up to Y memory devices, such as high bandwidth memory stacks or graphics double-data-rate, version 5, synchronous dynamic random-access memory, or other types of persistent storage.

In an embodiment, the memory interface 970 implements an HBM2 memory interface and Y equals half U. In an embodiment, the HBM2 memory stacks are located on the same physical package as the PPU 800, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 804 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 800 process very large datasets and/or run applications for extended periods.

In an embodiment, the PPU 800 implements a multi-level memory hierarchy. In an embodiment, the memory partition unit 880 supports a unified memory to provide a single unified virtual address space for CPU and PPU 800 memory, enabling data sharing between virtual memory systems. In an embodiment, the frequency of accesses by a PPU 800 to memory located on other processors is traced to ensure that memory pages are moved to the physical memory of the PPU 800 that is accessing the pages more frequently. In an embodiment, the NVLink 810 supports address translation services allowing the PPU 800 to directly access a CPU's page tables and providing full access to CPU memory by the PPU 800.

In an embodiment, copy engines transfer data between multiple PPUs 800 or between PPUs 800 and CPUs. The copy engines may generate page faults for addresses that are not mapped into the page tables. The memory partition unit 880 may then service the page faults, mapping the addresses into the page table, after which the copy engine may perform the transfer. In a conventional system, memory may be pinned (e.g., non-pageable) for multiple copy engine operations between multiple processors, substantially reducing the available memory. With hardware page faulting, addresses may be passed to the copy engines independent of whether the memory pages are in use, and the copying process may occur seamlessly.

Data from the memory 804 or other system memory may be fetched by the memory partition unit 880 and stored in the L2 cache 960, which is located on-chip and is shared between the various GPCs 850. As shown, each memory partition unit 880 includes a portion of the L2 cache 960 associated with a corresponding memory device (e.g., memory 804). Lower level caches may be implemented in various units within the GPCs 850. For example, each of the SMs 940 may implement a level one (L1) cache. The L1 cache is private memory that is dedicated to a particular SM 940. Data from the L2 cache 960 may be fetched and stored in each of the L1 caches for processing in the functional units of the SMs 940. The L2 cache 960 is coupled to the memory interface 970 and the Xbar 870.

The ROP unit 950 may perform graphics raster operations related to pixel color, such as color compression, pixel blending, and/or the like. The ROP unit 950 may implements depth testing in conjunction with the raster engine 925, receiving a depth for a sample location associated with a pixel fragment from the culling engine of the raster engine 925. The depth may be tested against a corresponding depth in a depth buffer for a sample location associated with the fragment. If the fragment passes the depth test for the sample location, the ROP unit 950 may update the depth buffer and transmit a result of the depth test to the raster engine 925. It will be appreciated that the number of partition units 880 may be different than the number of GPCs 850 and, therefore, each ROP unit 950 may be coupled to each of the GPCs 850. The ROP unit 950 may track packets received from the different GPCs 850 and determine to which GPC 850 a result generated by the ROP unit 950 is routed through the Xbar 870. Although the ROP unit 950 is included within the memory partition unit 880 in FIG. 9B, in some embodiments, the ROP unit 950 may be outside of the memory partition unit 880. For example, the ROP unit 950 may reside in the GPC 850 or another unit.

FIG. 10A illustrates the streaming multi-processor 940 of FIG. 9A, in accordance with an embodiment. As shown in FIG. 10A, the SM 940 includes an instruction cache 1005, one or more scheduler units 1010, a register file 1020, one or more processing cores 1050, one or more special function units (SFUs) 1052, one or more load/store units (LSUs) 1054, an interconnect network 1080, a shared memory/L1 cache 1070.

As described above, the work distribution unit 825 dispatches tasks for execution on the GPCs 850 of the PPU 800. The tasks are allocated to a particular DPC 920 within a GPC 850 and, if the task is associated with a shader program, the task may be allocated to an SM 940. The scheduler unit 1010 may receive the tasks from the work distribution unit 825 and manage instruction scheduling for one or more thread blocks assigned to the SM 940. The scheduler unit 1010 may schedule thread blocks for execution as warps of parallel threads, where each thread block may be allocated at least one warp. In an embodiment, each warp executes 32 threads. The scheduler unit 1010 may manage a plurality of different thread blocks, allocating the warps to the different thread blocks and then dispatching instructions from the plurality of different cooperative groups to the various functional units (e.g., cores 1050, SFUs 1052, and LSUs 1054) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 1015 may be configured to transmit instructions to one or more of the functional units. In the embodiment, the scheduler unit 1010 includes two dispatch units 1015 that enable two different instructions from the same warp to be dispatched during each clock cycle. In alternative embodiments, each scheduler unit 1010 may include a single dispatch unit 1015 or additional dispatch units 1015.

Each SM 940 may include a register file 1020 that provides a set of registers for the functional units of the SM 940. In an embodiment, the register file 1020 is divided between each of the functional units such that each functional unit is allocated a dedicated portion of the register file 1020. In some embodiments, the register file 1020 is divided between the different warps being executed by the SM 940. The register file 1020 provides temporary storage for operands connected to the data paths of the functional units.

Each SM 940 may comprise L processing cores 1050. In an embodiment, the SM 940 includes a large number (e.g., 128, etc.) of distinct processing cores 1050. Each core 1050 may include a fully pipelined, single-precision, double-precision, and/or mixed precision processing unit that includes a floating-point arithmetic logic unit and an integer arithmetic logic unit. In an embodiment, the floating-point arithmetic logic units implement the IEEE 754-2008 standard for floating-point arithmetic. In an embodiment, the cores 1050 include 64 single-precision (32-bit) floating-point cores, 64 integer cores, 32 double-precision (64-bit) floating-point cores, and 8 tensor cores.

Tensor cores configured to perform matrix operations, and, in an embodiment, one or more tensor cores are included in the cores 1050. In particular, the tensor cores may be configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating-point matrices, while the accumulation matrices C and D may be 16-bit floating-point or 32-bit floating-point matrices. Tensor Cores may operate on 16-bit floating-point input data with 32-bit floating-point accumulation. The 16-bit floating-point multiply requires 64 operations and results in a full precision product that is then accumulated using 32-bit floating-point addition with the other intermediate products for a 4×4×4 matrix multiply. In practice, Tensor Cores are often used to perform much larger two-dimensional or higher dimensional matrix operations, built up from these smaller elements. An API, such as CUDA C++ API, may expose specialized matrix load, matrix multiply and accumulate, and/or matrix store operations to efficiently use Tensor Cores from a CUDA-C++ program. At the CUDA level, the warp-level interface may assume 16×16 size matrices spanning all 32 threads of the warp.

Each SM 940 may comprise M SFUs 1052 that perform special functions (e.g., attribute evaluation, reciprocal square root, and the like). In an embodiment, the SFUs 1052 may include a tree traversal unit configured to traverse a hierarchical tree data structure. In an embodiment, the SFUs 1052 may include texture unit configured to perform texture map filtering operations. In an embodiment, the texture units are configured to load texture maps (e.g., a 2D array of texels) from the memory 804 and sample the texture maps to produce sampled texture values for use in shader programs executed by the SM 940. In an embodiment, the texture maps are stored in the shared memory/L1 cache 1070. The texture units may implement texture operations such as filtering operations using mip-maps (e.g., texture maps of varying levels of detail). In an embodiment, each SM 840 includes two texture units.

Each SM 940 may comprise N LSUs 1054 that implement load and store operations between the shared memory/L1 cache 1070 and the register file 1020. Each SM 940 may include an interconnect network 1080 that connects each of the functional units to the register file 1020 and the LSU 1054 to the register file 1020, shared memory/L1 cache 1070. In an embodiment, the interconnect network 1080 is a crossbar that can be configured to connect any of the functional units to any of the registers in the register file 1020 and connect the LSUs 1054 to the register file and memory locations in shared memory/L1 cache 1070.

The shared memory/L1 cache 1070 may be an array of on-chip memory that allows for data storage and communication between the SM 940 and the primitive engine 935 and between threads in the SM 940. In an embodiment, the shared memory/L1 cache 1070 comprises 128 KB of storage capacity and is in the path from the SM 940 to the partition unit 880. The shared memory/L1 cache 1070 can be used to cache reads and writes. One or more of the shared memory/L1 cache 1070, L2 cache 960, and memory 804 may be backing stores.

Combining data cache and shared memory functionality into a single memory block may provide the best overall performance for both types of memory accesses. The capacity may be usable as a cache by programs that do not use shared memory. For example, if shared memory is configured to use half of the capacity, texture and load/store operations may use the remaining capacity. Integration within the shared memory/L1 cache 1070 may enable the shared memory/L1 cache 1070 to function as a high-throughput conduit for streaming data while simultaneously providing high-bandwidth and low-latency access to frequently reused data.

When configured for general-purpose parallel computation, a simpler configuration may be used compared with graphics processing. For example, the fixed function graphics processing units shown in FIG. 8 may be bypassed, creating a much simpler programming model. In such a general-purpose parallel computation configuration, the work distribution unit 825 may assign and distribute blocks of threads directly to the DPCs 920. The threads in a block may execute the same program, using a unique thread ID in the calculation to ensure each thread generates unique results, using the SM 940 to execute the program and perform calculations, shared memory/L1 cache 1070 to communicate between threads, and the LSU 1054 to read and write global memory through the shared memory/L1 cache 1070 and the memory partition unit 880. When configured for general-purpose parallel computation, the SM 940 may write commands that the scheduler unit 820 can use to launch new work on the DPCs 920.

The PPU 800 may be included in a desktop computer, a laptop computer, a tablet computer, servers, supercomputers, a smart phone (e.g., a wireless, hand-held device), personal digital assistant (PDA), a digital camera, a vehicle, a head mounted display, a hand-held electronic device, and/or other devices. In an embodiment, the PPU 800 is embodied on a single semiconductor substrate. In another embodiment, the PPU 800 is included in a system-on-a-chip (SoC) along with one or more other devices such as additional PPUs 800, the memory, a reduced instruction set computer (RISC) CPU, a memory management unit (MMU), a digital-to-analog converter (DAC), and/or others.

In an embodiment, the PPU 800 may be included on a graphics card that includes one or more memory devices (e.g., memory 804). The graphics card may be configured to interface with a PCIe slot on a motherboard of a desktop computer. In some embodiments, the PPU 800 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes may be deployed in data centers, research facilities, and/or supercomputers to solve ever larger problems. As the number of processing devices within the high-performance systems increases, the communication and data transfer mechanisms may need to scale to support the increased bandwidth.

FIG. 10B is a conceptual diagram of a processing system 1000 implemented using the PPU 800 of FIG. 8, in accordance with an embodiment. The processing system 1000 includes a CPU 1030, switch 1032, and multiple PPUs 800 each and respective memories 804. The NVLink 810 may provide high-speed communication links between each of the PPUs 800. Although a particular number of NVLink 810 and interconnect 802 connections are illustrated in FIG. 10B, the number of connections to each PPU 800 and the CPU 1030 may vary. The switch 1032 may interface between the interconnect 802 and the CPU 1030. The PPUs 800, memories 804, and NVLinks 810 may be situated on a single semiconductor platform to form a parallel processing module 1025. In an embodiment, the switch 1032 supports two or more protocols to interface between various different connections and/or links.

In another embodiment (not shown), the NVLink 810 provides one or more high-speed communication links between each of the PPUs 800 and the CPU 1030 and the switch 1032 interfaces between the interconnect 802 and each of the PPUs 800. The PPUs 800, memories 804, and the interconnect 802 may be situated on a single semiconductor platform to form a parallel processing module 1025. In some embodiments (not shown), the interconnect 802 provides one or more communication links between each of the PPUs 800 and the CPU 1030, and the switch 1032 interfaces between each of the PPUs 800 using the NVLink 810 to provide one or more high-speed communication links between the PPUs 800. In some embodiments (not shown), the NVLink 810 provides one or more high-speed communication links between the PPUs 800 and the CPU 1030 through the switch 1032. In some embodiments (not shown), the interconnect 802 provides one or more communication links between each of the PPUs 800 directly. One or more of the NVLink 810 high-speed communication links may be implemented as a physical NVLink interconnect or either an on-chip or on-die interconnect using the same protocol as the NVLink 810.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may be situated separately or in various combinations of semiconductor platforms per the desires of the designer. In some embodiments, the parallel processing module 1025 may be implemented as a circuit board substrate and each of the PPUs 800 and/or memories 804 may be packaged devices. In an embodiment, the CPU 1030, switch 1032, and the parallel processing module 1025 are situated on a single semiconductor platform.

In an embodiment, the signaling rate of each NVLink 810 is 20 to 25 Gigabits/second and each PPU 800 includes six NVLink 810 interfaces (as shown in FIG. 10B, five NVLink 810 interfaces are included for each PPU 800). Each NVLink 810 may provide a particular data transfer rate (e.g., 25 Gigabytes/second) in each direction, with six links providing 800 Gigabytes/second. The NVLinks 810 may be used exclusively for PPU-to-PPU communication as shown in FIG. 10B, or some combination of PPU-to-PPU and PPU-to-CPU, when the CPU 1030 also includes one or more NVLink 810 interfaces.

In an embodiment, the NVLink 810 allows direct load/store/atomic access from the CPU 1030 to each PPU's 800 memory 804. In an embodiment, the NVLink 810 supports coherency operations, allowing data read from the memories 804 to be stored in the cache hierarchy of the CPU 1030, reducing cache access latency for the CPU 1030. In an embodiment, the NVLink 810 includes support for Address Translation Services (ATS), allowing the PPU 800 to directly access page tables within the CPU 1030. One or more of the NVLinks 810 may be configured to operate in a low-power mode.

FIG. 10C illustrates an exemplary system 1065 in which the processing system of FIG. 10B may be implemented, in accordance with some embodiments of the present disclosure. More specifically, FIG. 10C illustrates a system 1065 comprising at least one central processing unit 1030 that is connected to a communication bus 1075. The communication bus 1075 may be implemented using any suitable protocol, such as PCI (Peripheral Component Interconnect), PCI-Express, AGP (Accelerated Graphics Port), HyperTransport, or any other bus or point-to-point communication protocol(s). The system 1065 includes a main memory 1040. Control logic (software) and data may be stored in the main memory 1040, which may take the form of random-access memory (RAM).

Continuing with the example implementation illustrated in FIG. 10C, the system 1065 includes input devices 1060, the parallel processing system 1025, and display devices 1045, e.g. a conventional CRT (cathode ray tube), LCD (liquid crystal display), LED (light emitting diode), plasma display, and/or others. User input may be received from the input devices 1060, e.g., keyboard, mouse, touchpad, microphone, etc. Each of the foregoing modules and/or devices may be situated on a single semiconductor platform to form the system 1065. In some embodiments, the various modules may be situated separately or in various combinations of semiconductor platforms.

In some embodiments, the system 1065 may be coupled to a network (e.g., a telecommunications network, local area network (LAN), wireless network, wide area network (WAN) such as the Internet, peer-to-peer network, cable network, etc.) through a network interface 1035 for communication purposes.

The system 1065 may include a secondary storage (not shown), which may include a hard disk drive and/or a removable storage drive, representing a floppy disk drive, a magnetic tape drive, a compact disk drive, digital versatile disk (DVD) drive, recording device, universal serial bus (USB) flash memory, and/or others. The removable storage drive may read from and/or write to a removable storage unit in a well-known manner.

Computer programs, or computer control logic algorithms, may be stored in the main memory 1040 and/or the secondary storage. Such computer programs, when executed, enable the system 1065 to perform various functions. The main memory 1040, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1065 may take the form of a desktop computer, a laptop computer, a tablet computer, servers, supercomputers, a smart phone (e.g., a wireless, hand-held device), personal digital assistant (PDA), a digital camera, a vehicle, a head mounted display, a hand-held electronic device, a mobile phone device, a television, workstation, game consoles, embedded system, and/or any other device.

### Example Data Center

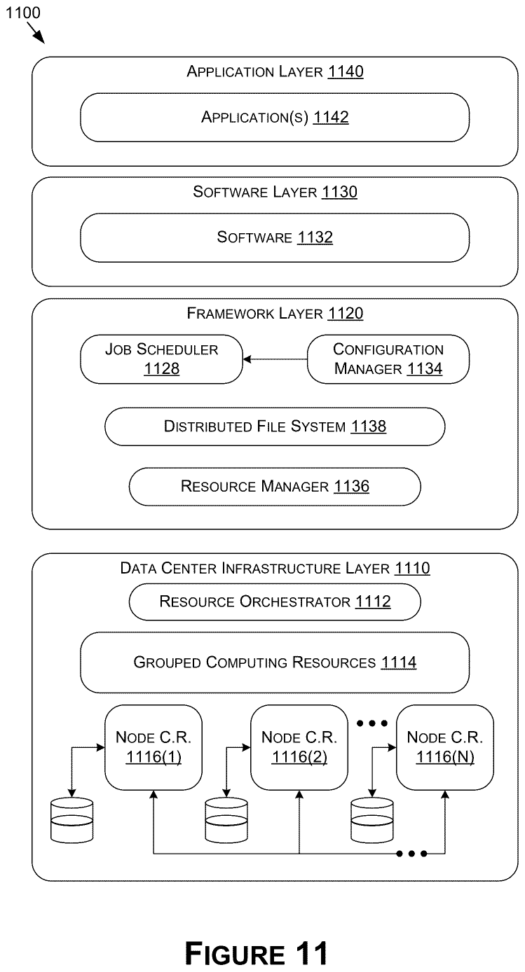

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may use distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of any known computing device(s). In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may be implemented using any known computing device(s). By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in the appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims. The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:
Clause 1. A processor comprising processing circuitry to select, based at least on processing a representation of one or more performance constraints using a configuration selection model, a first configuration of a multi-configuration model.
Clause 2. The processor of clause 1, wherein the processing circuitry is further to obtain the first configuration of the multi-configuration model during execution of the multi-configuration model.
Clause 3. The processor of clause 1 or 2, wherein the processing circuitry is further to select the first configuration of the multi-configuration model based at least on a representation of expected performance of the first configuration predicted using a performance estimation model associated with the multi-configuration model.
Clause 4. The processor of clause 1 or 2, wherein the configuration selection model is implemented based on at least one of: reinforcement learning, model predictive control, or Bayesian optimization.
Clause 5. The processor of clause 1 or 2, wherein the configuration selection model implements a multi-class classifier.
Clause 6. The processor of clause 1 or 2, wherein the configuration selection model supports a number of classes corresponding to a number of indexed parameters of a plurality of supported configurations of the multi-configuration model.
Clause 7. The processor of clause 1 or 2, wherein the configuration selection model supports a number of classes corresponding to a number of indexed configurations of the multi-configuration model.
Clause 8. The processor of clause 1 or 2, wherein the processing of the representation of the one or more performance constraints comprises predicting a representation of expected performance of the first configuration of the multi-configuration model and comparing the expected performance to the one or more performance constraints.
Clause 9. The processor of clause 1 or 2, wherein the processing of the representation of the one or more performance constraints comprises predicting, based at least on determining that a predicted performance of a currently active configuration of the multi-configuration model does not satisfy the one or more performance constraints, a representation of expected performance of one or more alternate adapted configurations of the multi-configuration model comprising the adapted configuration.
Clause 10. The processor of clause 1 or 2, wherein the processing circuitry is further to select the configuration selection model from a plurality of supported configuration selection models based at least on the one or more performance constraints.
Clause 11. The processor of clause 1 or 2, wherein the processing circuitry is further to select the first configuration of the multi-configuration model based at least on processing a representation of the one or more performance constraints and one or more resource profiles quantifying one or more resource metrics of the processor using the configuration selection model.
Clause 12. The processor of clause 1 or 2, wherein the processing circuitry is further to identify the first configuration from a look-up table indexed based at least on a parameterized representation of an architecture of the adapted configuration.
Clause 13. The processor of clause 1 or 2, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 14. A method comprising determining, during execution of a multi-configuration model, a first configuration of the multi-configuration model selected based at least on processing a representation of one or more performance constraints using a configuration selection model.
Clause 15. The method of clause 14, further comprising selecting the first configuration of the multi-configuration model based at least on a representation of expected performance of the first configuration predicted using a performance estimation model associated with the multi-configuration model.
Clause 16. The method of clause 14, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 17. A system comprising one or more processors to control, within a simulation rendered using one or more light transport simulation techniques, one or more operations of one or more simulated agents in a simulated environment based at least on one or more outputs of one or more configurations of one or more multi-configuration models, the one or more configurations being computed during execution of the multi-configuration model and selected based at least on processing a representation of one or more performance constraints using a configuration selection model.
Clause 18. The system of clause 17, wherein the simulation is generated, at least in part, using one or more content creation applications of a three-dimensional (3D) content collaboration platform for 3D assets.
Clause 19. The system of clause 18, wherein the simulated environment is represented in at least one content creation application of the one or more content creation applications using an OpenUSD format.
Clause 20. The system of clause 17, wherein the one or more simulated agents comprise at least one of: one or more simulated ego-machines, one or more digital twins, or one or more digital characters.
Clause 21. The system of clause 17, wherein at least one multi-configuration model of the one or more multi-configuration models is implemented in at least one processing node of a plurality of processing nodes of a data center and accessible to one or more remote clients via at least one of: an application programming interface (API), or an application plug-in.
Clause 22. A processor comprising processing circuitry to generate one or more resource profiles quantifying one or more resource metrics of the processor.
Clause 23. The processor of clause 22, wherein the processing circuitry is further to generate, based at least on the one or more resource profiles, a configuration of a multi-configuration model during execution of the multi-configuration model using the processor.
Clause 24. The processor of clause 22 or 23, wherein the processing circuitry is further to generate the configuration of the multi-configuration model based at least on a current resource profile of the one or more resource profiles quantifying a current state of a compute engine of the processor.
Clause 25. The processor of clause 22 or 23, wherein the processing circuitry is further to generate the configuration of the multi-configuration model based at least on the one or more resource profiles quantifying an activity level of a fetch pipeline of the processor.
Clause 26. The processor of clause 22 or 23, wherein the processing circuitry is further to generate the configuration of the multi-configuration model based at least on one or more predicted future resource metrics of the one or more resource metrics of the processor, the predicted future resource metrics generated based at least on applying a representation of a current internal resource profile of the processor to a resource prediction model.
Clause 27. The processor of clause 22 or 23, wherein the processing circuitry is further to generate the configuration of the multi-configuration model based at least on one or more predicted future resource metrics of the one or more resource metrics of the processor, the predicted future resource metrics generated based at least on applying a representation of one or more categories of computational graph operations to a resource prediction model.
Clause 28. The processor of clause 22 or 23, wherein the processing circuitry is further to generate the configuration of the multi-configuration model based at least on a predicted future resource profile of the processor generated based at least on processing a representation of a computation graph corresponding to the multi-configuration model using a transformer neural network.
Clause 29. The processor of clause 22 or 23, wherein the processing circuitry is further to generate the configuration of the multi-configuration model based at least on an external resource profile quantifying one or more external resource metrics of one or more resources that exist outside the processor.
Clause 30. The processor of clause 22 or 23, wherein the processing circuitry is further to generate the configuration of the multi-configuration model based at least on multiple resource profiles of the one or more resource profiles comprising a current internal resource profile of the processor and one or more predicted future internal resource profiles of the processor.
Clause 31. The processor of clause 22 or 23, wherein the processing circuitry is further to identify the configuration from a look-up table indexed based at least on a parameterized representation of an architecture of the configuration.
Clause 32. The processor of clause 22 or 23, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 33. A method comprising computing, based at least on one or more resource profiles quantifying one or more resource metrics of a processor, a configuration of a multi-configuration model during execution of the multi-configuration model using the processor.
Clause 34. The method of clause 33, further comprising generating the configuration of the multi-configuration model based at least on a current resource profile of the one or more resource profiles quantifying a current state of a compute engine of the processor.
Clause 35. The method of clause 33, further comprising generating the configuration of the multi-configuration model based at least on the one or more resource profiles quantifying an activity level of a fetch pipeline of the processor.
Clause 36. The method of clause 33, further comprising generating the configuration of the multi-configuration model based at least on one or more predicted future resource metrics of the one or more resource metrics of the processor, the predicted future resource metrics generated based at least on applying a representation of one or more categories of computational graph operations to a resource prediction model.
Clause 37. The method of clause 33, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 38. A system comprising one or more processors to control, within a simulation rendered using one or more light transport simulation techniques, one or more operations of one or more simulated agents in a simulated environment based at least on one or more outputs of one or more configurations of one or more multi-configuration models, the one or more configurations being determined during execution of the multi-configuration model on the one or more processors based at least on one or more resource profiles quantifying one or more resource metrics of the one or more processors.
Clause 39. The system of clause 38, wherein the simulation is generated, at least in part, using one or more content creation applications of a three-dimensional (3D) content collaboration platform for 3D assets.
Clause 40. The system of clause 39, wherein the simulated environment is represented in at least one content creation application of the one or more content creation applications using an OpenUSD format.
Clause 41. The system of clause 38, wherein the one or more simulated agents comprise at least one of: one or more simulated ego-machines, one or more digital twins, or one or more digital characters.
Clause 42. The system of clause 38, wherein at least one multi-configuration model of the one or more multi-configuration models is implemented in at least one processing node of a plurality of processing nodes of a data center and accessible to one or more remote clients via at least one of an application programming interface (API), or an application plug-in.

What is claimed is:

1. A processor comprising processing circuitry to:
generate one or more resource profiles quantifying one or more resource metrics of the processor; and
generate, based at least on the one or more resource profiles, a configuration of a multi-configuration model during execution of the multi-configuration model using the processor.

2. The processor of claim 1, wherein the processing circuitry is further to generate the configuration of the multi-configuration model based at least on a current resource profile of the one or more resource profiles quantifying a current state of a compute engine of the processor.

3. The processor of claim 1, wherein the processing circuitry is further to generate the configuration of the multi-configuration model based at least on the one or more resource profiles quantifying an activity level of a fetch pipeline of the processor.

4. The processor of claim 1, wherein the processing circuitry is further to generate the configuration of the multi-configuration model based at least on one or more predicted future resource metrics of the one or more resource metrics of the processor, the predicted future resource metrics generated based at least on applying a representation of a current internal resource profile of the processor to a resource prediction model.

5. The processor of claim 1, wherein the processing circuitry is further to generate the configuration of the multi-configuration model based at least on one or more predicted future resource metrics of the one or more resource metrics of the processor, the predicted future resource metrics generated based at least on applying a representation of one or more categories of computational graph operations to a resource prediction model.

6. The processor of claim 1, wherein the processing circuitry is further to generate the configuration of the multi-configuration model based at least on a predicted future resource profile of the processor generated based at least on processing a representation of a computation graph corresponding to the multi-configuration model using a transformer neural network.

7. The processor of claim 1, wherein the processing circuitry is further to generate the configuration of the multi-configuration model based at least on an external resource profile quantifying one or more external resource metrics of one or more resources that exist outside the processor.

8. The processor of claim 1, wherein the processing circuitry is further to generate the configuration of the multi-configuration model based at least on multiple resource profiles of the one or more resource profiles comprising a current internal resource profile of the processor and one or more predicted future internal resource profiles of the processor.

9. The processor of claim 1, wherein the processing circuitry is further to identify the configuration from a look-up table indexed based at least on a parameterized representation of an architecture of the configuration.

10. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).

11. A method comprising:
computing, based at least on one or more resource profiles quantifying one or more resource metrics of a processor, a configuration of a multi-configuration model during execution of the multi-configuration model using the processor.

12. The method of claim 11, further comprising generating the configuration of the multi-configuration model based at least on a current resource profile of the one or more resource profiles quantifying a current state of a compute engine of the processor.

13. The method of claim 11, further comprising generating the configuration of the multi-configuration model based at least on the one or more resource profiles quantifying an activity level of a fetch pipeline of the processor.

14. The method of claim 11, further comprising generating the configuration of the multi-configuration model based at least on one or more predicted future resource metrics of the one or more resource metrics of the processor, the predicted future resource metrics generated based at least on applying a representation of one or more categories of computational graph operations to a resource prediction model.

15. The method of claim 11, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).

16. A system comprising:
one or more processors to control, within a simulation rendered using one or more light transport simulation techniques, one or more operations of one or more simulated agents in a simulated environment based at least on one or more outputs of one or more configurations of one or more multi-configuration models, the one or more configurations being determined during execution of the multi-configuration model on the one or more processors based at least on one or more resource profiles quantifying one or more resource metrics of the one or more processors.

17. The system of claim 16, wherein the simulation is generated, at least in part, using one or more content creation applications of a three-dimensional (3D) content collaboration platform for 3D assets.

18. The system of claim 17, wherein the simulated environment is represented in at least one content creation application of the one or more content creation applications using an OpenUSD format.

19. The system of claim 16, wherein the one or more simulated agents comprise at least one of: one or more simulated ego-machines, one or more digital twins, or one or more digital characters.

20. The system of claim 16, wherein at least one multi-configuration model of the one or more multi-configuration models is implemented in at least one processing node of a plurality of processing nodes of a data center and accessible to one or more remote clients via at least one of an application programming interface (API), or an application plug-in.
